(19) United States
(12) Patent Application Publication
(10) Pub. No.: US 2023/0055718 A1
(43) Pub. Date: Feb. 23, 2023

(54) HEAT TRANSFER COMPOSITIONS, METHODS, AND SYSTEMS

(71) Applicant: HONEYWELL INTERNATIONAL INC., Charlotte, NC (US)

(72) Inventors: Kaimi Gao, Charlotte, NC (US); Henna Tangri, Charlotte, NC (US); Ankit Sethi, Charlotte, NC (US); Ryan Hulse, Charlotte, NC (US)

(73) Assignee: HONEYWELL INTERNATIONAL INC., Charlotte, NC (US)

(21) Appl. No.: 17/872,434

(22) Filed: Jul. 25, 2022

Related U.S. Application Data
(60) Provisional application No. 63/235,184, filed on Aug. 20, 2021.

(51) Int. Cl. C09K 5/04; F25B 1/00

(52) U.S. Cl. CPC C09K 5/045; F25B 1/00; C09K 2205/22; C09K 2205/40; C09K 2205/122

(57) ABSTRACT

The present invention relates to a refrigerant composition comprising at least about 98.5% by weight of the following three compounds, with each compound being present in the following relative percentages:
33.0% to 45% by weight difluoromethane (HFC-32);
48.5% to 67.0% by weight of 2,3,3,3-tetrafluoropropene (HFO-1234yf); and
1.0% to 6.0% by weight fluoroethane (HFC-161), and to the use of the refrigerant in a heat exchange system, including air conditioning, refrigeration applications and heat pump applications and to the use of such compositions as a replacement of the refrigerant R-410A or R-32 or R-454B for heating and cooling applications.

### CROSS REFERENCE TO RELATED APPLICATION

This application claims the priority benefit of U.S. Provisional Application 63/235,184, filed Aug. 20, 2021, which is incorporated herein by reference in its entirety.

### FIELD OF THE INVENTION

This invention relates to compositions, methods, and systems having utility in heat transfer applications, with particular benefit in stationary air conditioning and heat pump systems, and in particular aspects to refrigerant compositions for replacement of the refrigerant R-410A for various heating and cooling applications, including: (1) as a replacement for R-410A in stationary air conditioning and heat pump systems, medium temperature refrigeration systems and low temperature refrigeration systems; and (2) as a replacement or retrofit for R-32 and R454B in stationary air conditioning and heat pump systems, medium temperature refrigeration systems and low temperature refrigeration systems.

### BACKGROUND

Mechanical refrigeration systems, and related heat transfer devices such as heat pumps, chillers and air conditioners, are well known in the art for industrial, commercial, and domestic uses. Several fluorocarbon-based fluids have found widespread use in many residential, commercial and industrial applications, including as the working fluid in systems such as air conditioning, heat pump and refrigeration systems. Because of certain suspected environmental problems, including the relatively high global warming potentials associated with the use of some hydrofluorocarbon (“HFC”) based compositions that have heretofore been used in these applications, it has become increasingly desirable to use fluids having global warming potentials (“GWPs”) less than 300.

A commonly used refrigerant in many applications has been R-410A (50:50 by weight blend of pentafluoroethane (HFC-125) and difluoromethane (HFC-32)). R-410A has an estimated GWP of 2088.

It is generally considered important that any potential sub-300 GWP substitute for R-410A must also possess those properties present in many of the most widely used HFC based fluids, such as excellent heat transfer properties, chemical stability, acceptable mild flammability or non-flammability, and lubricant compatibility, among others.

With regard to efficiency in use, it is important to note that a loss in refrigerant thermodynamic performance or energy efficiency may have secondary environmental impacts through increased fossil fuel usage arising from an increased demand for electrical energy. In other words, a proposed new refrigerant that has a GWP below 300 might nevertheless be less environmentally friendly than the fluid it is replacing if another characteristic of the proposed new fluid, such as efficiency in use, results in increased environmental emissions indirectly, such as by requiring higher fuel combustion to achieve the same level of refrigeration. It is thus seen that the selection of a replacement is a complicated, challenging endeavor that may not have predictable results.

Furthermore, it is generally considered desirable for HFC refrigerant substitutes to be effective without major engineering changes, or with changes limited to the compressor and possibly a small number of other components, to conventional vapor compression technology currently used with HFC refrigerants.

It is critical for maintenance of system efficiency and proper and reliable functioning of the compressor, that lubricant circulating in a vapor compression heat transfer system is returned to the compressor to perform its intended lubricating function. Otherwise, lubricant might accumulate and become lodged in the coils and piping of the system, including in the heat transfer components. Furthermore, when lubricant accumulates on the inner surfaces of the evaporator, it lowers the heat exchange efficiency of the evaporator, and thereby reduces the efficiency of the system. For these reasons, it is desirable for many systems that the refrigerant is miscible over at least the operating temperature range of the system with the lubricant that is used in the system.

The difficulty of achieving a refrigerant that is capable of at once achieving many or all of the above-noted properties is illustrated, for example, by the refrigerants disclosed in CN102746525 (“CN525”). In particular, CN525 discloses a large number of refrigerant blends, and included among these refrigerants are blends that comprise a combination of R32, R161 and HFO1234yf, where the amount of each compound is within prescribed ranges. The minimum amount of R161 in such blends is disclosed to be 20% by weight and the maximum amount of R32 is disclosed to be 20% by weight. As a result of testing conducted by applicants, as explained in detail below, this refrigerant blend is deficient in at least one of the important properties identified above, and the novel refrigerants according to the present invention are unexpectedly able to achieve a difficult-to-achieve combination of important properties that is not possible by following the teachings of CN525, including particularly nonflammability.

### SUMMARY OF THE INVENTION

Applicants have found that the compositions of the present invention satisfy in an exceptional and unexpected way the need for sub-300 GWP alternatives and/or replacements for R-410A that are only mildly flammable (i.e., have a 2L classification according to ANSI/ASHRAE 34-2019, Designation and Safety Classification of Refrigerants), have acceptable toxicity (are Class A under ASHRAE 34), and that have a close match in cooling efficiency and capacity to R-410A, and which also preferably have a glide that is not excessively high. As used herein, the term “sub-300 GWP” is used for convenience to refer to refrigerants which have a GWP (measured as described hereinafter) of 300 or less.

The present invention includes refrigerants comprising at least 98.5% by weight of the following three compounds, with each compound being present in the following relative percentages:
33.0% to 45% by weight difluoromethane (HFC-32);
48.5% to 67.0% by weight of 2,3,3,3-tetrafluoropropene (HFO-1234yf); and
1.0% to less than 7.0% by weight of fluoroethane (HFC-161), provided that the refrigerant is a Class A2L refrigerant and has a GWP of less than 300. Refrigerants as described in this paragraph are sometimes referred to for convenience as Refrigerant 1.

The present invention includes refrigerants comprising at least 98.5% by weight of the following three compounds, with each compound being present in the following relative percentages:
from 40% to 45% by weight HFC-32;
from 50% to 55% by weight of HFO-1234yf; and
from 1.0% to 6.0% by weight of HFC-161, provided that the refrigerant is a Class A2L refrigerant and has a GWP of less than 300. Refrigerants as described in this paragraph are sometimes referred to for convenience as Refrigerant 2.

The present invention includes refrigerants consisting essentially of the following three compounds, with each compound being present in the following relative percentages:
33.0% to 45% by weight of HFC-32;
48.5% to 67.0% by weight of HFO-1234yf; and
1.0% to 6.0% by weight of HFC-161, provided that the refrigerant is a Class A2L refrigerant and has a GWP of less than 300. Refrigerants as described in this paragraph are sometimes referred to for convenience as Refrigerant 3.

The present invention includes refrigerants consisting essentially of the following three compounds, with each compound being present in the following relative percentages:
from 40% to 45% by weight HFC-32;
from 50% to 55% by weight of HFO-1234yf; and
from 1.0% to 6.0% by weight of HFC-161, provided that the refrigerant is a Class A2L refrigerant and has a GWP of less than 300. Refrigerants as described in this paragraph are sometimes referred to for convenience as Refrigerant 4.

The present invention includes refrigerants consisting essentially of the following three compounds, with each compound being present in the following relative percentages:
from 41.5% to 44.5% by weight HFC-32;
from 49.5% to 53.5% by weight of HFO-1234yf; and
from 2.0% to 6.0% by weight of HFC-161. Refrigerants as described in this paragraph are sometimes referred to for convenience as Refrigerant 5.

The present invention includes refrigerants consisting essentially of the following three compounds, with each compound being present in the following relative percentages:
from 43.5% +0.5/-2% by weight HFC-32;
from 52.5% +2/-0.5% by weight of HFO-1234yf; and
from 4% +0.5/-2% by weight of HFC-161. Refrigerants as described in this paragraph are sometimes referred to for convenience as Refrigerant 6.

The present invention includes refrigerants consisting of the following three compounds, with each compound being present in the following relative percentages:
from 43.5% +0.5/-2% by weight HFC-32;
from 52.5% +2/-0.5% by weight of HFO-1234yf; and
from 4% +0.5/-2% by weight of HFC-161. Refrigerants as described in this paragraph are sometimes referred to for convenience as Refrigerant 7.

The present invention includes refrigerants consisting essentially of the following three compounds, with each compound being present in the following relative percentages:
from 43.5% +0.5/-2% by weight HFC-32;
from 51.5% +2/-0.5% by weight of HFO-1234yf; and
from 4% +0.5/-2% by weight of HFC-161, provided that the refrigerant is a Class A2L refrigerant and has a GWP of less than 300. Refrigerants as described in this paragraph are sometimes referred to for convenience as Refrigerant 8.

The present invention includes refrigerants consisting of the following three compounds, with each compound being present in the following relative percentages:
43.5% by weight HFC-32;
52.5% by weight of HFO-1234yf; and
4% by weight of HFC-161. Refrigerants as described in this paragraph are sometimes referred to for convenience as Refrigerant 9.

The present invention includes refrigerants consisting of the following three compounds, with each compound being present in the following relative percentages:
43.5% by weight HFC-32;
52.5% by weight of HFO-1234yf; and
4% by weight of HFC-161, whereby the refrigerant is a Class A2L refrigerant and has a GWP of less than 300. Refrigerants as described in this paragraph are sometimes referred to for convenience as Refrigerant 10.

### BRIEF DESCRIPTION OF THE DRAWINGS

FIG. 1 is a schematic representation of an exemplary heat transfer system useful in air conditioning, low temperature refrigeration and medium temperature refrigeration.

FIG. 2 is a schematic representation of an exemplary heat transfer system useful in low and medium temperature refrigeration and which includes a vapor injector.

FIG. 3 is a schematic representation of an exemplary heat transfer system useful in low and medium temperature refrigeration and which includes a liquid injector.

FIG. 4 is a schematic representation of an exemplary heat transfer system useful in low and medium temperature refrigeration and which includes a suction line /liquid line heat exchanger.

FIG. 5 is a schematic representation of an exemplary heat transfer system useful in low and medium temperature refrigeration and which includes a vapor injector and an oil separator.

### DETAILED DESCRIPTION OF THE INVENTION

### Definitions

For the purposes of this invention, the term “about” in relation to the amounts expressed in weight percent for amounts greater than 2% means that the amount of the component can vary by an amount of +/- 2% by weight.

For the purposes of this invention, the term “about” in relation to temperatures in degrees centigrade (°C) means that the stated temperature can vary by an amount of +/-5° C.

The term “capacity” is the amount of cooling provided, in BTUs/hour, by the refrigerant in the refrigeration system. This is experimentally determined by multiplying the change in enthalpy in BTU/pound, of the refrigerant as it passes through the evaporator by the mass flow rate of the refrigerant. The enthalpy can be determined from the measurement of the pressure and temperature of the refrigerant. The capacity of the refrigeration system relates to the ability to maintain an area to be cooled at a specific temperature. The capacity of a refrigerant represents the amount of cooling or heating that it provides and provides some measure of the capability of a compressor to pump quantities of heat for a given volumetric flow rate of refrigerant. In other words, given a specific compressor, a refrigerant with a higher capacity will deliver more cooling or heating power.

The phrase “coefficient of performance” (hereinafter “COP”) is a universally accepted measure of refrigerant performance, especially useful in representing the relative thermodynamic efficiency of a refrigerant in a specific heating or cooling cycle involving evaporation or condensation of the refrigerant. In refrigeration engineering, this term expresses the ratio of useful refrigeration or cooling capacity to the energy applied by the compressor in compressing the vapor and therefore expresses the capability of a given compressor to pump quantities of heat for a given volumetric flow rate of a heat transfer fluid, such as a refrigerant. In other words, given a specific compressor, a refrigerant with a higher COP will deliver more cooling or heating power. One means for estimating COP of a refrigerant at specific operating conditions is from the thermodynamic properties of the refrigerant using standard refrigeration cycle analysis techniques (see for example, R.C. Downing, FLUOROCARBON REFRIGERANTS HANDBOOK, Chapter 3, Prentice-Hall, 1988 which is incorporated herein by reference in its entirety).

The phrase “discharge temperature” refers to the temperature of the refrigerant at the outlet of the compressor. The advantage of a low discharge temperature is that it permits the use of existing equipment without activation of the thermal protection aspects of the system which are preferably designed to protect compressor components and avoids the use of costly controls such as liquid injection to reduce discharge temperature.

The phrase “Global Warming Potential” (hereinafter “GWP”) was developed to allow comparisons of the global warming impact of different gases. Specifically, it is a measure of how much energy the emission of one ton of a gas will absorb over a given period of time, relative to the emission of one ton of carbon dioxide. The larger the GWP, the more that a given gas warms the Earth compared to CO2 over that time period. The time period usually used for GWP is 100 years. GWP provides a common measure, which allows analysts to add up emission estimates of different gases. See http://www.protocolodemontreal.org.br/site/images/publicacoes/setor_manufatura_equipam entos_refrigeracao_arcondicionado/Como_calcular_el_Potencial_de_Calentamiento_Atmos ferico_en_las_mezclas_de_refrigerantes.pdf

The term “Occupational Exposure Limit (OEL)” is determined in accordance with ASHRAE Standard 34-2016 Designation and Safety Classification of Refrigerants.

The phrase “acceptable toxicity” as used herein means the composition is classified as class “A” by ASHRAE Standard 34-2016 Designation and Safety Classification of Refrigerants and described in Appendix B1 to ASHRAE Standard 34-2016 (as each standard exists as of the filing date of this application). A substance which is non-flammable and low-toxicity would be classified as “A1” by ASHRAE Standard 34-2016 Designation and Safety Classification of Refrigerants and described in Appendix B1 to ASHRAE Standard 34-2016 (as each standard exists as of the filing date of this application).

The term “mass flow rate” is the mass of refrigerant passing through a conduit per unit of time.

As used herein, the term “replacement” means the use of a composition of the present invention in a heat transfer system that had been designed for use with or is suitable for use with another refrigerant. By way of example, when a refrigerant or heat transfer composition of the present invention is used in a heat transfer system that was designed for use with R-410A, then the refrigerant or heat transfer composition of the present invention is a replacement for R-410A in said system. It will thus be understood that the term “replacement” includes the use of the refrigerants and heat transfer compositions of the present invention in both new and existing systems that had been designed for use with, are commonly used with, or are suitable for use with R-410A.

The phrase “thermodynamic glide” applies to zeotropic refrigerant mixtures that have varying temperatures during phase change processes in the evaporator or condenser at constant pressure.

As used herein, the term “evaporator glide” means the difference between the saturation temperature of the refrigerant at the entrance to the evaporator and the dew point of the refrigerant at the exit of the evaporator, assuming the pressure at the evaporator exit is the same as the pressure at the inlet. As used herein, the phrase “saturation temperature” means the temperature at which the liquid refrigerant boils into vapor at a given pressure.

The term “low temperature refrigeration system” refers to heat transfer systems which operate with a condensing temperature of from about 20° C. to about 60° C. and evaporating temperature of from about -45° C. up to and including -12° C.

The term “medium temperature refrigeration system” refers to heat transfer systems which operate with a condensing temperature of from about 20° C. to about 60° C. and evaporating temperature of from -12° C. to about 0° C.

The term “residential air conditioning” as used herein refers to heat transfer systems to condition air (cooling or heating) which operate with a condensing temperature of from about 20° C. to about 70° C. and evaporating temperature of from about 0° C. to about 20° C.

The term “residential air-to-water heat pump” as used herein refers to heat transfer systems which transfer heat from outdoor air to water within the residence, which water is in turn used to condition the air in the residence and which operates with a condensing temperature of from about 20° C. to about 70° C. and evaporating temperature of from about -20° C. to about 3° C.

The term “air cooled chillers” as used herein refers to heat transfer systems which transfer heat to or from process water (typically used to cool or heat the inside of buildings) and reject or absorb heat from ambient air and which operate with a condensing temperature of from about 20° C. to about 70° C. and evaporating temperature of from about 0° C. to about 10° C.

The term “supermarket refrigeration” as used herein refers to commercial refrigeration systems that are used to maintain chilled or frozen food in both product display cases and storage refrigerators.

The terms “variable refrigerant flow system” and “VRF system” each means an air conditioning system configuration which uses more than one indoor evaporator, and which has the ability to control the amount of refrigerant flowing to the plural evaporators.

The terms “HFO-1234yf” and “R-1234yf” as used herein each mean 2,3,3,3-tetrafluoropropene.

The terms “HFC-32” and “R-32” as used herein each mean difluoromethane.

The terms “HFC-161” and “R-161” as used herein each mean fluoroethane.

The term “R-454B” as used herein means a refrigerant comprising a blend of 68.9% by weight of R-32 and 31.1% by weight of R-1234yf.

Reference herein to a group of defined items includes all such defined items, including all such items with suffix designations.

### Refrigerants and Heat Transfer Compositions

Applicants have found that the refrigerants of the present invention, including each of Refrigerants 1 - 10 as described herein, is capable of providing exceptionally advantageous properties including: heat transfer properties, acceptable toxicity, mild flammability (i.e., is Class 2L), zero or near zero ozone depletion potential (“ODP”), and lubricant compatibility, including miscibility with POE and/or PVE lubricants over the operating temperature and concentration ranges used in stationary air conditioning systems (including residential air conditioning, commercial air conditioning, VRF air conditioning), chillers (including air cooled chillers), heat pump systems (including residential air-to-water heat pump systems), , medium temperature refrigeration and low temperature refrigeration.

A particular advantage of the refrigerants of the present invention, including specifically each of Refrigerants 1 -10, is that they are mildly flammable and have acceptable toxicity, that is, each is a Class A2L refrigerant. It will be appreciated by the skilled person that the flammability of a refrigerant can be a characteristic that is given consideration in certain important heat transfer applications, and that refrigerants that are classified as 2L can frequently be an advantage over refrigerants that are considered to be flammable. Thus, it is a desire in the art to provide a refrigerant composition which can be used as a replacement for 410A (or as a replacement or retrofit for R-32 and for R454B) which has excellent heat transfer properties, acceptable toxicity, zero or near zero ODP, and lubricant compatibility, including miscibility with POE and/or PVE lubricants over the operating temperature and concentration ranges used in stationary air conditioning systems (including residential air conditioning, commercial air conditioning, VRF air conditioning), chillers (including air cooled chillers), heat pump systems (including residential air-to-water heat pump systems), and commercial refrigeration (including medium temperature refrigeration and low temperature refrigeration) , and which maintains non-flammability in use. This desirable advantage can be achieved met by the refrigerants of the present invention, which is a surprising and unexpected result.

Applicants have found that the refrigerant compositions of the invention, including each of Refrigerants 1 - 10, are capable of achieving a difficult-to-achieve combination of properties including particularly low GWP. Thus, the compositions of the invention have a GWP of 300 or less and preferably 295 or less.

In addition, the refrigerant compositions of the invention, including each of Refrigerants 1 - 10, have a zero or near zero ODP. Thus, the compositions of the invention have an ODP of not greater than 0.02, and more preferably zero.

In addition, the refrigerant compositions of the invention, including each of Refrigerants 1 - 10, show acceptable toxicity and preferably have an OEL of greater than about 400. As those skilled in the art are aware, a non-flammable refrigerant that has an OEL of greater than about 400 is advantageous since it results in the refrigerant being classified in the desirable Class A of ASHRAE standard 34.

The preferred refrigerant compositions of the invention show both acceptable toxicity and mild flammability under ASHRAE standard 34 and are therefore Class A2L refrigerants. Applicants have found that the heat transfer compositions of the present invention, including heat transfer compositions that include each of Refrigerants 1 - 10 as described herein, are capable of providing an exceptionally advantageous and unexpected combination of properties including: good heat transfer properties, chemical stability under the conditions of use, acceptable toxicity, mild-flammability, zero or near zero ozone depletion potential (“ODP”), and lubricant compatibility, including miscibility with POE and/or PVE lubricants over the operating temperature and concentration ranges used in stationary air conditioning systems (including residential air conditioning, commercial air conditioning, VRF air conditioning), chillers (including air cooled chillers), heat pump systems (including residential air-to-water heat pump systems), and commercial refrigeration (including medium temperature refrigeration and low temperature refrigeration) as well as being sub-300 GWP, especially as a replacement for R-410A, or as a replacement or a retrofit for R-32 or R454B in such systems.

The heat transfer compositions can consist essentially of any refrigerant of the present invention, including each of Refrigerants 1-10.

The heat transfer compositions of the present invention can consist of any refrigerant of the present invention, including each of Refrigerants 1-10.

The heat transfer compositions of the invention may include other components for the purpose of enhancing or providing certain functionality to the compositions. Such other components may include, in addition to the refrigerant of the present invention, including each of Refrigerants 1 - 10, one or more of lubricants, passivators, flammability suppressants, dyes, solubilizing agents, compatibilizers, stabilizers, antioxidants, corrosion inhibitors, extreme pressure additives and anti-wear additives and other compounds and/or components that modulate a particular property of the heat transfer composition, and the presence of all such compounds and components is within the broad scope of the invention.

### Lubricants

The heat transfer compositions of the invention can comprise a refrigerant as described herein, including each of Refrigerants 1 - 10, and a lubricant. Heat transfer compositions as described in this paragraph are sometimes referred to for convenience as Heat Transfer Composition 1.

The heat transfer compositions of the invention can also comprise a refrigerant as described herein, including each of Refrigerants 1 - 10, and a polyol ester (POE) lubricant. Heat transfer compositions as described in this paragraph are sometimes referred to for convenience as Heat Transfer Composition 2.

The heat transfer composition of the invention particularly comprises Refrigerant 7 and a POE lubricant. Heat transfer compositions as described in this paragraph are sometimes referred to for convenience as Heat Transfer Composition 3.

The heat transfer composition of the invention particularly comprises Refrigerant 8 and a POE lubricant. Heat transfer compositions as described in this paragraph are sometimes referred to for convenience as Heat Transfer Composition 4.

The heat transfer composition of the invention particularly comprises Refrigerant 9 and a POE lubricant. Heat transfer compositions as described in this paragraph are sometimes referred to for convenience as Heat Transfer Composition 5.

The heat transfer composition of the invention particularly comprises Refrigerant 10 and a POE lubricant. Heat transfer compositions as described in this paragraph are sometimes referred to for convenience as Heat Transfer Composition 6.

The heat transfer composition of the invention particularly comprises Refrigerant 7 and a polyvinyl ether (PVE) lubricant. Heat transfer compositions as described in this paragraph are sometimes referred to for convenience as Heat Transfer Composition 7.

The heat transfer composition of the invention particularly comprises Refrigerant 8 and a PVE lubricant. Heat transfer compositions as described in this paragraph are sometimes referred to for convenience as Heat Transfer Composition 8.

The heat transfer composition of the invention particularly comprises Refrigerant 9 and a PVE lubricant. Heat transfer compositions as described in this paragraph are sometimes referred to for convenience as Heat Transfer Composition 9.

The heat transfer composition of the invention particularly comprises Refrigerant 10 and a PVE lubricant. Heat transfer compositions as described in this paragraph are sometimes referred to for convenience as Heat Transfer Composition 10.

Applicants have found that the heat transfer compositions of the present invention, including each of Heat Transfer Compositions 1 - 10, are capable of providing exceptionally advantageous and unexpected combination of properties including, in addition to the advantageous properties identified herein with respect to the refrigerant, excellent refrigerant/lubricant compatibility, including miscibility with POE and/or PVE lubricants, over the operating temperature and concentration ranges used in stationary air conditioning systems (including residential air conditioning, commercial air conditioning, VRF air conditioning), chillers (including air cooled chillers), heat pump systems (including residential air-to-water heat pump systems), and commercial refrigeration (including medium temperature refrigeration and low temperature refrigeration) .

A lubricant consisting essentially of a POE having a viscosity at 40° C. measured in accordance with ASTM D445 of from about 30 to about 70 is referred to herein as Lubricant 1.

Commercially available POEs that are preferred for use in the present heat transfer compositions include neopentyl glycol dipelargonate which is available as Emery 2917 (registered trademark) and Hatcol 2370 (registered trademark) and pentaerythritol derivatives including those sold under the trade designations Emkarate RL32-3MAF and Emkarate RL68H by CPI Fluid Engineering. Emkarate RL32-3MAF and Emkarate RL68H are preferred POE lubricants having the properties identified below:

| | | |
|---|---|---|
| Property | RL32-3MAF | RL68H |
| Viscosity @ 40° C. (ASTM D445), cSt | about 31 | about 67 |
| Viscosity @ 100° C. (ASTM D445), cSt | about 5.6 | about 9.4 |
| Pour Point (ASTM D97), °C | about -40 | about -40 |

A preferred heat transfer composition comprises a refrigerant of the present invention, including each of Refrigerants 1-10 and Lubricant 1. Heat transfer compositions as described in this paragraph are sometimes referred to for convenience as Heat Transfer Composition 11.

A preferred heat transfer composition comprises Refrigerant 7 and Lubricant 1. Heat transfer compositions as described in this paragraph are sometimes referred to for convenience as Heat Transfer Composition 12.

A preferred heat transfer composition comprises Refrigerant 8 and Lubricant 1. Heat transfer compositions as described in this paragraph are sometimes referred to for convenience as Heat Transfer Composition 13.

A preferred heat transfer composition comprises Refrigerant 9 and Lubricant 1. Heat transfer compositions as described in this paragraph are sometimes referred to for convenience as Heat Transfer Composition 14.

A preferred heat transfer composition comprises Refrigerant 10 and Lubricant 1. Heat transfer compositions as described in this paragraph are sometimes referred to for convenience as Heat Transfer Composition 15.

A lubricant consisting essentially of a POE having a viscosity at 40° C. measured in accordance with ASTM D445 of from about 30 to about 70 based on the weight of the heat transfer composition, is referred to herein as Lubricant 2.

Commercially available polyvinyl ethers that are preferred for use in the present heat transfer compositions that have a viscosity at 40° C. measured in accordance with ASTM D445 of from about 30 to about 70 include those lubricants sold under the trade designations FVC32D and FVC68D, from Idemitsu.

A preferred heat transfer composition comprises a refrigerant of the present invention, including each of Refrigerants 1-10 and Lubricant 2. Heat transfer compositions as described in this paragraph are sometimes referred to for convenience as Heat Transfer Composition 16.

A preferred heat transfer composition comprises Refrigerant 7 and Lubricant 2. Heat transfer compositions as described in this paragraph are sometimes referred to for convenience as Heat Transfer Composition 17.

A preferred heat transfer composition comprises Refrigerant 8 and Lubricant 2. Heat transfer compositions as described in this paragraph are sometimes referred to for convenience as Heat Transfer Composition 18.

A preferred heat transfer composition comprises Refrigerant 9 and Lubricant 2. Heat transfer compositions as described in this paragraph are sometimes referred to for convenience as Heat Transfer Composition 19.

A preferred heat transfer composition comprises Refrigerant 10 and Lubricant 2. Heat transfer compositions as described in this paragraph are sometimes referred to for convenience as Heat Transfer Composition 20.

The invention comprises includes heat transfer compositions of the present invention, including each of Heat Transfer Compositions 1 - 20, wherein the lubricant is present in the heat transfer composition in an amount of from about 0.1% by weight to about 5% by weight of the heat transfer composition. Heat transfer compositions as described in this paragraph are sometimes referred to for convenience as Heat Transfer Composition 21.

The invention comprises includes heat transfer compositions of the present invention, including each of Heat Transfer Compositions 1 - 20, wherein the lubricant is present in the heat transfer composition in an amount of from about 0.1% by weight to about 2% by weight of the heat transfer composition. Heat transfer compositions as described in this paragraph are sometimes referred to for convenience as Heat Transfer Composition 22.

The invention comprises includes heat transfer compositions of the present invention, including each of Heat Transfer Compositions 1 - 20, wherein the lubricant is present in the heat transfer composition in an amount of from about 0.1% by weight to about 1% by weight of the heat transfer composition. Heat transfer compositions as described in this paragraph are sometimes referred to for convenience as Heat Transfer Composition 23.

The invention comprises includes heat transfer compositions of the present invention, including each of Heat Transfer Compositions 1 - 20, wherein the lubricant is present in the heat transfer composition in an amount of from about 0.1% by weight to about 0.5% by weight of the heat transfer composition. Heat transfer compositions as described in this paragraph are sometimes referred to for convenience as Heat Transfer Composition 24.

The invention comprises includes heat transfer compositions of the present invention, including each of Heat Transfer Compositions 1 - 20, wherein the lubricant is present in the heat transfer composition in an amount of from about 0.2% by weight to about 0.5% by weight of the heat transfer composition. Heat transfer compositions as described in this paragraph are sometimes referred to for convenience as Heat Transfer Composition 25.

Other additives not mentioned herein can also be included by those skilled in the art in view of the teaching contained herein without departing from the novel and basic features of the present invention.

Combinations of surfactants and solubilizing agents may also be added to the present compositions to aid oil solubility as disclosed in U.S. Pat. No. 6,516,837, the disclosure of which is incorporated by reference in its entirety.

### Methods, Uses and Systems

### Systems

The present invention includes heat transfer systems of all types that include refrigerants of the present invention, including each of Refrigerants 1 -10, and/or that include heat transfer compositions of the invention, including each of Heat Transfer Compositions 1-25. Heat transfer systems as described in this paragraph are sometimes referred to for convenience as Heat Transfer System 1.

The present invention also includes, and provides particular advantage in connection with, stationary air conditioning systems that include refrigerants of the present invention, including each of Refrigerants 1 - 10, and/or that include heat transfer compositions of the invention, including each of Heat Transfer Compositions 1- 25. Heat transfer systems as described in this paragraph are sometimes referred to for convenience as Heat Transfer System 2.

The present invention also includes, and provides particular advantage in connection with, stationary residential air conditioning systems that include refrigerants of the present invention, including each of Refrigerants 1 -10, and/or that include heat transfer compositions of the invention, including each of Heat Transfer Compositions 1- 25. Heat transfer systems as described in this paragraph are sometimes referred to for convenience as Heat Transfer System 3.

The present invention also includes, and provides particular advantage in connection with, stationary commercial air conditioning systems that include refrigerants of the present invention, including each of Refrigerants 1 -10, and/or that include heat transfer compositions of the invention, including each of Heat Transfer Compositions 1- 25. Heat transfer systems as described in this paragraph are sometimes referred to for convenience as Heat Transfer System 4.

The present invention also includes, and provides particular advantage in connection with, stationary VRF air conditioning systems that include refrigerants of the present invention, including each of Refrigerants 1 - 10, and/or that include heat transfer compositions of the invention, including each of Heat Transfer Compositions 1- 25. Heat transfer systems as described in this paragraph are sometimes referred to for convenience as Heat Transfer System 5.

The present invention also includes, and provides particular advantage in connection with, chillers (including air-cooled chillers) that include refrigerants of the present invention, including each of Refrigerants 1 - 10, and/or that include heat transfer compositions of the invention, including each of Heat Transfer Compositions 1- 25. Heat transfer systems as described in this paragraph are sometimes referred to for convenience as Heat Transfer System 6.

The present invention also includes, and provides particular advantage in connection with, heat pump systems (including residential air-to-water heat pump systems) that include refrigerants of the present invention, including each of Refrigerants 1 -10, and/or that include heat transfer compositions of the invention, including each of Heat Transfer Compositions 1-25. Heat transfer systems as described in this paragraph are sometimes referred to for convenience as Heat Transfer System 7.

The present invention also includes, and provides particular advantage in connection with, commercial refrigeration (including low temperature commercial refrigeration and medium temperature commercial refrigeration) that include refrigerants of the present invention, including each of Refrigerants 1 -10, and/or that include heat transfer compositions of the invention, including each of Heat Transfer Compositions 1- 25. Heat transfer systems as described in this paragraph are sometimes referred to for convenience as Heat Transfer System 8.

The heat transfer systems include those identified by the indicated Heat Transfer System number in the following table, with the number in the Refrigerant column being reference to the Refrigerant number as defined herein.

| Heat Transfer System No. | System Type | Refrigerant No. | Heat Transfer No. |
|---|---|---|---|
| 2A | stationary air conditioning systems | 7 | NA |
| 2B | stationary air conditioning systems | 7 | NA |
| 2C | stationary air conditioning systems | 8 | NA |
| 2D | stationary air conditioning systems | 9 | NA |
| 2E | stationary air conditioning systems | 10 | NA |
| 2F | stationary air conditioning systems | NA | 15 |
| 2G | stationary air conditioning systems | NA | 20 |
| 3A | stationary residential air conditioning systems | 1 | |
| 3B | stationary residential air conditioning systems | 7 | |
| 3C | stationary residential air conditioning systems | 8 | |
| 3D | stationary residential air conditioning systems | 9 | |
| 3E | stationary residential air conditioning systems | 10 | |
| 3F | stationary residential air conditioning systems | NA | 15 |
| 3G | stationary residential air conditioning systems | NA | 20 |
| 4A | stationary commercial air conditioning systems | 1 | |
| 4B | stationary commercial air conditioning systems | 7 | |
| 4C | stationary commercial air conditioning systems | 8 | |
| 4D | stationary commercial air conditioning systems | 9 | |
| 4E | stationary commercial air conditioning systems | 10 | |
| 4F | stationary commercial air conditioning systems | NA | 15 |
| 4G | stationary commercial air conditioning systems | NA | 20 |
| 4A | stationary commercial air conditioning systems | 1 | |
| 4B | stationary commercial air conditioning systems | 7 | |
| 4C | stationary commercial air conditioning systems | 8 | |
| 4D | stationary commercial air conditioning systems | 9 | |
| 4E | stationary commercial air conditioning systems | 10 | |
| 4F | stationary commercial air conditioning systems | NA | 15 |
| 4G | stationary commercial air conditioning systems | NA | 20 |
| 5A | stationary VRF air conditioning systems | 1 | |
| 5B | stationary VRF air conditioning systems | 7 | |
| 5C | stationary VRF air conditioning systems | 8 | |
| 5D | stationary VRF air conditioning systems | 9 | |
| 5E | stationary VRF air conditioning systems | 10 | |
| 5F | stationary VRF air conditioning systems | NA | 15 |
| 5G | stationary VRF air conditioning systems | NA | 20 |
| 6A | chillers (including air-cooled chillers) | 1 | |
| 6B | chillers (including air-cooled chillers) | 7 | |
| 6C | chillers (including air-cooled chillers) | 8 | |
| 6D | chillers (including air-cooled chillers) | 9 | |
| 6E | chillers (including air-cooled chillers) | 10 | |
| 6F | chillers (including air-cooled chillers) | NA | 15 |
| 6G | chillers (including air-cooled chillers) | NA | 20 |
| 7A | heat pump systems (including residential air-to-water heat pumps) | 1 | |
| 7B | heat pump systems (including residential air-to-water heat pumps) | 7 | |
| 7C | heat pump systems (including residential air-to-water heat pumps) | 8 | |
| 7D | heat pump systems (including residential air-to-water heat pumps) | 9 | |
| 7E | heat pump systems (including residential air-to-water heat pumps) | 10 | |
| 7F | heat pump systems (including residential air-to-water heat pumps) | NA | 15 |
| 7G | heat pump systems (including residential air-to-water heat pump systems) | NA | 20 |
| 8A | commercial refrigeration (including low and medium temperature refrigeration) | 1 | |
| 8B | commercial refrigeration (including low and medium temperature refrigeration) | 7 | |
| 8C | commercial refrigeration (including low and medium temperature refrigeration) | 8 | |
| 8D | commercial refrigeration (including low and medium temperature refrigeration) | 9 | |
| 8E | commercial refrigeration (including low and medium temperature refrigeration) | 10 | |
| 8F | commercial refrigeration (including low and medium temperature refrigeration) | NA | 15 |
| 8G | commercial refrigeration (including low and medium temperature refrigeration) | NA | 20 |

Examples of residential air conditioning systems that can be used with advantage with the refrigerants of the present invention, including each of Refrigerants 1 - 10, and/or with include heat transfer compositions of the invention, including each of Heat Transfer Compositions 1- 25, include ducted split or a ductless split, window or portable air-conditioning systems.

Examples of commercial air conditioning systems that can be used with advantage with the refrigerants of the present invention, including each of Refrigerants 1 - 10, and/or with include heat transfer compositions of the invention, including each of Heat Transfer Compositions 1- 25 include chiller systems, supermarket refrigeration, packaged rooftop units, and commercial variable refrigerant flow (VRF) systems).

Examples of heat pumps that can be used with advantage with the refrigerants of the present invention, including each of Refrigerants 1 - 10, and/or with include heat transfer compositions of the invention, including each of Heat Transfer Compositions 1- 25 include: residential air to water heat pump/hydronic systems and commercial air source, water source or ground source heat pump systems.

Examples of chillers that can be used with advantage with the refrigerants of the present invention, including each of Refrigerants 1 - 10, and/or with include heat transfer compositions of the invention, including each of Heat Transfer Compositions 1- 25 include positive displacement chillers and air cooled or water-cooled direct expansion chillers (which can be either modular or conventionally singularly packaged),

For heat transfer systems of the present invention that include a compressor and lubricant for the compressor in the system, the system can comprises a loading of refrigerant of the present, including each of Refrigerants 1 - 10, and lubricant, including POE and PVE lubricant, such that the lubricant loading in the system is from about 5% to 60% by weight, or from about 10% to about 60% by weight, or from about 20% to about 50% by weight, or from about 20% to about 40% by weight, or from about 20% to about 30% by weight, or from about 30% to about 50% by weight, or from about 30% to about 40% by weight. As used herein, the term “lubricant loading” refers to the total weight of lubricant contained in the system as a percentage of total of lubricant and refrigerant contained in the system. Such systems may also include a lubricant loading of from about 5% to about 10% by weight, or about 8 % by weight of the heat transfer composition.

### Exemplary Heat Transfer Systems

As described in detail below, the preferred systems of the present invention comprise a compressor, a condenser, an expansion device and an evaporator, all connected in fluid communication using piping, valving and control systems such that the refrigerant and associated components of the heat transfer composition can flow through the system in known fashion to complete the refrigeration cycle. An exemplary schematic of such a basic system is illustrated in FIG. 1. In particular, the system schematically illustrated in FIG. 1 shows a compressor 10, which provides compressed refrigerant vapor to condenser 20. The compressed refrigerant vapor is condensed to produce a liquid refrigerant which is then directed to an expansion device 40 that produces refrigerant at reduced temperature pressure, which in turn is then provided to evaporator 50. In evaporator 50 the liquid refrigerant absorbs heat from the body or fluid being cooled, thus producing a refrigerant vapor which is then provided to the suction line of the compressor.

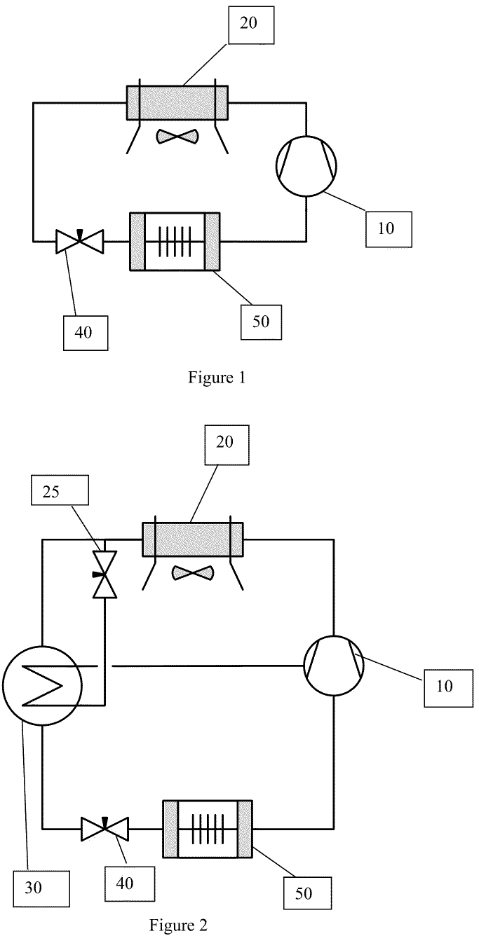

The refrigeration system illustrated in FIG. 2 is the same as described above in connection with FIG. 1 except that it includes a vapor injection system including heat exchanger 30 and bypass expansion valve 25. The bypass expansion device 25 diverts a portion of the refrigerant flow at the condenser outlet through the device and thereby provides liquid refrigerant to heat exchanger 30 at a reduced pressure, and hence at a lower temperature, to heat exchanger 30. This relatively cool liquid refrigerant then exchanges heat with the remaining, relatively high temperature liquid from the condenser. This operation produces a subcooled liquid to the main expansion device 40 and evaporator 50 and returns a relatively cool refrigerant vapor to the compressor 10. In this way the injection of the cooled refrigerant vapor into the suction side of the compressor serves to maintain compressor discharge temperatures in acceptable limits, which can be especially advantageous in low temperature systems that utilize high compression ratios.

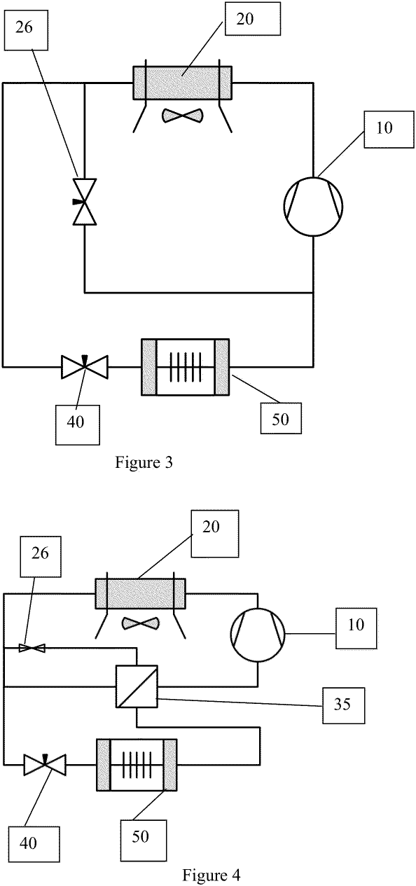

The refrigeration system illustrated in FIG. 3 is the same as described above in connection with FIG. 1 except that it includes a liquid injection system including bypass valve 26. The bypass valve 26 diverts a portion of the liquid refrigerant exiting the condenser to the compressor, preferably to a liquid injection port in the compressor 10. In this way the injection of liquid refrigerant into the suction side of the compressor serves to maintain compressor discharge temperatures in acceptable limits, which can be especially advantageous in low temperature systems that utilize high compression ratios.

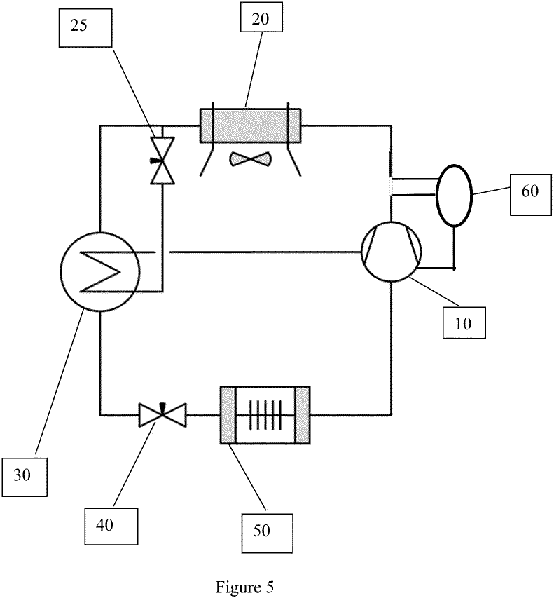

The refrigeration system illustrated in FIG. 4 is the same as described above in connection with FIG. 1 except that it includes a liquid line/suction line heat exchanger 35. The valve 26 diverts a portion of the of the refrigerant flow at the condenser outlet to the liquid line/suction line heat exchanger, where heat is transferred from the liquid refrigerant to the refrigerant vapor leaving evaporator 50.

The refrigeration system illustrated in FIG. 5 is the same as described above in connection with FIG. 1 except that it includes an oil separator 60 connected to the outlet of the compressor 10. As is known to those skilled in the art, some amount of compressor lubricant will typically be carried over into the compressor discharge refrigerant vapor, and the oil separator is included to provide means to disengage the lubricant liquid from the refrigerant vapor, and a result refrigerant vapor which has a reduced lubricant oil content, proceeds to the condenser inlet and liquid lubricant is then returned to the lubricant reservoir for use in lubricating the compressor, such as a lubricant receiver. In preferred embodiments, the oil separator includes the sequestration materials described herein, preferably in the form of a filter or solid core.

It will be appreciated by those skilled in the art that the different equipment/configuration options shown separately in each of FIGS. 2-5 can be combined and used together as deemed advantageous for any application.

### Uses

### General Uses

The present invention also includes, and provides particular advantage in connection with, use of the refrigerants of the present invention, including each of Refrigerants 1 - 10, in stationary air conditioning systems.

The present invention also includes, and provides particular advantage in connection with, use of Refrigerant 7 in stationary air conditioning systems.

The present invention also includes, and provides particular advantage in connection with, use of Refrigerant 8 in stationary air conditioning systems.

The present invention also includes, and provides particular advantage in connection with, use of Refrigerant 9 in stationary air conditioning systems.

The present invention also includes, and provides particular advantage in connection with, use of Refrigerant 10 in stationary air conditioning systems.

The present invention also includes, and provides particular advantage in connection with, use of the refrigerants of the present invention, including each of Refrigerants 1 - 10, in chillers.

The present invention also includes, and provides particular advantage in connection with, use of Refrigerant 7 in chillers.

The present invention also includes, and provides particular advantage in connection with, use of Refrigerant 8 in chillers.

The present invention also includes, and provides particular advantage in connection with, use of Refrigerant 9 in chiller systems.

The present invention also includes, and provides particular advantage in connection with, use of Refrigerant 10 in chiller systems.

The present invention also includes, and provides particular advantage in connection with, use of the refrigerants of the present invention, including each of Refrigerants 1 - 10, in heat pump systems.

The present invention also includes, and provides particular advantage in connection with, use of Refrigerant 7 in heat pump systems.

The present invention also includes, and provides particular advantage in connection with, use of Refrigerant 8 in heat pump systems.

The present invention also includes, and provides particular advantage in connection with, use of Refrigerant 9 in heat pump systems.

The present invention also includes, and provides particular advantage in connection with, use of Refrigerant 10 in heat pump systems.

The present invention also includes, and provides particular advantage in connection with, use of the refrigerants of the present invention, including each of Refrigerants 1 - 10, in commercial refrigeration systems.

The present invention also includes, and provides particular advantage in connection with, use of Refrigerant 7 in commercial refrigeration systems.

The present invention also includes, and provides particular advantage in connection with, use of Refrigerant 8 in commercial refrigeration systems.

The present invention also includes, and provides particular advantage in connection with, use of Refrigerant 9 in commercial refrigeration systems.

The present invention also includes, and provides particular advantage in connection with, use of Refrigerant 10 in commercial refrigeration systems.

### Replacement Uses

The present invention also includes, and provides particular advantage in connection with, use of the refrigerants of the present invention, including each of Refrigerants 1 - 10, as a replacement for R-410. The various replacement uses described in the following table are included in the present invention, with the number in the Replacement Refrigerant being reference to the Refrigerant Number as defined herein.

| Existing Refrigerant | Existing Refrigerant System | Replacement Refrigerant |
|---|---|---|
| R410A | All | 1 |
| R410A | All | 2 |
| R410A | All | 3 |
| R410A | All | 4 |
| R410A | All | 5 |
| R410A | All | 6 |
| R410A | All | 7 |
| R410A | All | 8 |
| R410A | All | 9 |
| R410A | All | 10 |
| R410A | stationary air conditioning | 1 |
| R410A | stationary air conditioning | 2 |
| R410A | stationary air conditioning | 3 |
| R410A | stationary air conditioning | 4 |
| R410A | stationary air conditioning | 5 |
| R410A | stationary air conditioning | 6 |
| R410A | stationary air conditioning | 7 |
| R410A | stationary air conditioning | 8 |
| R410A | stationary air conditioning | 9 |
| R410A | stationary air conditioning | 10 |
| R410A | stationary residential air conditioning | 1 |
| R410A | stationary residential air conditioning | 2 |
| R410A | stationary residential air conditioning | 3 |
| R410A | stationary residential air conditioning | 4 |
| R410A | stationary residential air conditioning | 5 |
| R410A | stationary residential air conditioning | 6 |
| R410A | stationary residential air conditioning | 7 |
| R410A | stationary residential air conditioning | 8 |
| R410A | stationary residential air conditioning | 9 |
| R410A | stationary residential air conditioning | 10 |
| R410A | stationary commercial air conditioning | 1 |
| R410A | stationary commercial air conditioning | 2 |
| R410A | stationary commercial air conditioning | 3 |
| R410A | stationary commercial air conditioning | 4 |
| R410A | stationary commercial air conditioning | 5 |
| R410A | stationary commercial air conditioning | 6 |
| R410A | stationary commercial air conditioning | 7 |
| R410A | stationary commercial air conditioning | 8 |
| R410A | stationary commercial air conditioning | 9 |
| R410A | stationary commercial air conditioning | 10 |
| R410A | stationary residential air conditioning | 10 |
| R410A | stationary VRF air conditioning | 1 |
| R410A | stationary VRF air conditioning | 2 |
| R410A | stationary VRF air conditioning | 3 |
| R410A | stationary VRF air conditioning | 4 |
| R410A | stationary VRF air conditioning | 5 |
| R410A | stationary VRF air conditioning | 6 |
| R410A | stationary VRF air conditioning | 7 |
| R410A | stationary VRF air conditioning | 8 |
| R410A | stationary VRF air conditioning | 9 |
| R410A | stationary VRF air conditioning | 10 |
| R410A | chiller (including air cooled chillers) | 1 |
| R410A | chiller (including air cooled chillers) | 2 |
| R410A | chiller (including air cooled chillers) | 3 |
| R410A | chiller (including air cooled chillers) | 4 |
| R410A | chiller (including air cooled chillers) | 5 |
| R410A | chiller (including air cooled chillers) | 6 |
| R410A | chiller (including air cooled chillers) | 7 |
| R410A | chiller (including air cooled chillers) | 8 |
| R410A | chiller (including air cooled chillers) | 9 |
| R410A | chiller (including air cooled chillers) | 10 |
| R410A | heat pump | 1 |
| R410A | heat pump | 2 |
| R410A | heat pump | 3 |
| R410A | heat pump | 4 |
| R410A | heat pump | 5 |
| R410A | heat pump | 6 |
| R410A | heat pump | 7 |
| R410A | heat pump | 8 |
| R410A | heat pump | 9 |
| R410A | heat pump | 10 |
| R410A | residential air-to-water heat pump | 1 |
| R410A | residential air-to-water heat pump | 2 |
| R410A | residential air-to-water heat pump | 3 |
| R410A | residential air-to-water heat pump | 4 |
| R410A | residential air-to-water heat pump | 5 |
| R410A | residential air-to-water heat pump | 6 |
| R410A | residential air-to-water heat pump | 7 |
| R410A | residential air-to-water heat pump | 8 |
| R410A | residential air-to-water heat pump | 9 |
| R410A | residential air-to-water heat pump | 10 |
| R410A | commercial refrigeration | 1 |
| R410A | commercial refrigeration | 2 |
| R410A | commercial refrigeration | 3 |
| R410A | commercial refrigeration | 4 |
| R410A | commercial refrigeration | 5 |
| R410A | commercial refrigeration | 6 |
| R410A | commercial refrigeration | 7 |
| R410A | commercial refrigeration | 8 |
| R410A | commercial refrigeration | 9 |
| R410A | commercial refrigeration | 10 |
| R410A | commercial low temperature refrigeration | 1 |
| R410A | commercial low temperature refrigeration | 2 |
| R410A | commercial low temperature refrigeration | 3 |
| R410A | commercial low temperature refrigeration | 4 |
| R410A | commercial low temperature refrigeration | 5 |
| R410A | commercial low temperature refrigeration | 6 |
| R410A | commercial low temperature refrigeration | 7 |
| R410A | commercial low temperature refrigeration | 8 |
| R410A | commercial low temperature refrigeration | 9 |
| R410A | commercial low temperature refrigeration | 10 |
| R410A | commercial medium temperature refrigeration | 1 |
| R410A | commercial medium temperature refrigeration | 2 |
| R410A | commercial medium temperature refrigeration | 3 |
| R410A | commercial medium temperature refrigeration | 4 |
| R410A | commercial medium temperature refrigeration | 5 |
| R410A | commercial medium temperature refrigeration | 6 |
| R410A | commercial medium temperature refrigeration | 7 |
| R410A | commercial medium temperature refrigeration | 8 |
| R410A | commercial medium temperature refrigeration | 9 |
| R410A | commercial medium temperature refrigeration | 10 |
| R32 | All | 1 |
| R32 | All | 2 |
| R32 | All | 3 |
| R32 | All | 4 |
| R32 | All | 5 |
| R32 | All | 6 |
| R32 | All | 7 |
| R32 | All | 8 |
| R32 | All | 9 |
| R32 | All | 10 |
| R32 | stationary air conditioning | 1 |
| R32 | stationary air conditioning | 2 |
| R32 | stationary air conditioning | 3 |
| R32 | stationary air conditioning | 4 |
| R32 | stationary air conditioning | 5 |
| R32 | stationary air conditioning | 6 |
| R32 | stationary air conditioning | 7 |
| R32 | stationary air conditioning | 8 |
| R32 | stationary air conditioning | 9 |
| R32 | stationary air conditioning | 10 |
| R32 | stationary residential air conditioning | 1 |
| R32 | stationary residential air conditioning | 2 |
| R32 | stationary residential air conditioning | 3 |
| R32 | stationary residential air conditioning | 4 |
| R32 | stationary residential air conditioning | 5 |
| R32 | stationary residential air conditioning | 6 |
| R32 | stationary residential air conditioning | 7 |
| R32 | stationary residential air conditioning | 8 |
| R32 | stationary residential air conditioning | 9 |
| R32 | stationary residential air conditioning | 10 |
| R32 | stationary commercial air conditioning | 1 |
| R32 | stationary commercial air conditioning | 2 |
| R32 | stationary commercial air conditioning | 3 |
| R32 | stationary commercial air conditioning | 4 |
| R32 | stationary commercial air conditioning | 5 |
| R32 | stationary commercial air conditioning | 6 |
| R32 | stationary commercial air conditioning | 7 |
| R32 | stationary commercial air conditioning | 8 |
| R32 | stationary commercial air conditioning | 9 |
| R32 | stationary commercial air conditioning | 10 |
| R32 | stationary residential air conditioning | 10 |
| R32 | stationary VRF air conditioning | 1 |
| R32 | stationary VRF air conditioning | 2 |
| R32 | stationary VRF air conditioning | 3 |
| R32 | stationary VRF air conditioning | 4 |
| R32 | stationary VRF air conditioning | 5 |
| R32 | stationary VRF air conditioning | 6 |
| R32 | stationary VRF air conditioning | 7 |
| R32 | stationary VRF air conditioning | 8 |
| R32 | stationary VRF air conditioning | 9 |
| R32 | stationary VRF air conditioning | 10 |
| R32 | chiller (including air cooled chillers) | 1 |
| R32 | chiller (including air cooled chillers) | 2 |
| R32 | chiller (including air cooled chillers) | 3 |
| R32 | chiller (including air cooled chillers) | 4 |
| R32 | chiller (including air cooled chillers) | 5 |
| R32 | chiller (including air cooled chillers) | 6 |
| R32 | chiller (including air cooled chillers) | 7 |
| R32 | chiller (including air cooled chillers) | 8 |
| R32 | chiller (including air cooled chillers) | 9 |
| R32 | chiller (including air cooled chillers) | 10 |
| R32 | heat pump | 1 |
| R32 | heat pump | 2 |
| R32 | heat pump | 3 |
| R32 | heat pump | 4 |
| R32 | heat pump | 5 |
| R32 | heat pump | 6 |
| R32 | heat pump | 7 |
| R32 | heat pump | 8 |
| R32 | heat pump | 9 |
| R32 | heat pump | 10 |
| R32 | residential air-to-water heat pump | 1 |
| R32 | residential air-to-water heat pump | 2 |
| R32 | residential air-to-water heat pump | 3 |
| R32 | residential air-to-water heat pump | 4 |
| R32 | residential air-to-water heat pump | 5 |
| R32 | residential air-to-water heat pump | 6 |
| R32 | residential air-to-water heat pump | 7 |
| R32 | residential air-to-water heat pump | 8 |
| R32 | residential air-to-water heat pump | 9 |
| R32 | residential air-to-water heat pump | 10 |
| R32 | commercial refrigeration | 1 |
| R32 | commercial refrigeration | 2 |
| R32 | commercial refrigeration | 3 |
| R32 | commercial refrigeration | 4 |
| R32 | commercial refrigeration | 5 |
| R32 | commercial refrigeration | 6 |
| R32 | commercial refrigeration | 7 |
| R32 | commercial refrigeration | 8 |
| R32 | commercial refrigeration | 9 |
| R32 | commercial refrigeration | 10 |
| R32 | commercial low temperature refrigeration | 1 |
| R32 | commercial low temperature refrigeration | 2 |
| R32 | commercial low temperature refrigeration | 3 |
| R32 | commercial low temperature refrigeration | 4 |
| R32 | commercial low temperature refrigeration | 5 |
| R32 | commercial low temperature refrigeration | 6 |
| R32 | commercial low temperature refrigeration | 7 |
| R32 | commercial low temperature refrigeration | 8 |
| R32 | commercial low temperature refrigeration | 9 |
| R32 | commercial low temperature refrigeration | 10 |
| R32 | commercial medium temperature refrigeration | 1 |
| R32 | commercial medium temperature refrigeration | 2 |
| R32 | commercial medium temperature refrigeration | 3 |
| R32 | commercial medium temperature refrigeration | 4 |
| R32 | commercial medium temperature refrigeration | 5 |
| R32 | commercial medium temperature refrigeration | 6 |
| R32 | commercial medium temperature refrigeration | 7 |
| R32 | commercial medium temperature refrigeration | 8 |
| R32 | commercial medium temperature refrigeration | 9 |
| R32 | commercial medium temperature refrigeration | 10 |
| R454B | All | 1 |
| R454B | All | 2 |
| R454B | All | 3 |
| R454B | All | 4 |
| R454B | All | 5 |
| R454B | All | 6 |
| R454B | All | 7 |
| R454B | All | 8 |
| R454B | All | 9 |
| R454B | All | 10 |
| R454B | stationary air conditioning | 1 |
| R454B | stationary air conditioning | 2 |
| R454B | stationary air conditioning | 3 |
| R454B | stationary air conditioning | 4 |
| R454B | stationary air conditioning | 5 |
| R454B | stationary air conditioning | 6 |
| R454B | stationary air conditioning | 7 |
| R454B | stationary air conditioning | 8 |
| R454B | stationary air conditioning | 9 |
| R454B | stationary air conditioning | 10 |
| R454B | stationary residential air conditioning | 1 |
| R454B | stationary residential air conditioning | 2 |
| R454B | stationary residential air conditioning | 3 |
| R454B | stationary residential air conditioning | 4 |
| R454B | stationary residential air conditioning | 5 |
| R454B | stationary residential air conditioning | 6 |
| R454B | stationary residential air conditioning | 7 |
| R454B | stationary residential air conditioning | 8 |
| R454B | stationary residential air conditioning | 9 |
| R454B | stationary residential air conditioning | 10 |
| R454B | stationary commercial air conditioning | 1 |
| R454B | stationary commercial air conditioning | 2 |
| R454B | stationary commercial air conditioning | 3 |
| R454B | stationary commercial air conditioning | 4 |
| R454B | stationary commercial air conditioning | 5 |
| R454B | stationary commercial air conditioning | 6 |
| R454B | stationary commercial air conditioning | 7 |
| R454B | stationary commercial air conditioning | 8 |
| R454B | stationary commercial air conditioning | 9 |
| R454B | stationary commercial air conditioning | 10 |
| R454B | stationary residential air conditioning | 10 |
| R454B | stationary VRF air conditioning | 1 |
| R454B | stationary VRF air conditioning | 2 |
| R454B | stationary VRF air conditioning | 3 |
| R454B | stationary VRF air conditioning | 4 |
| R454B | stationary VRF air conditioning | 5 |
| R454B | stationary VRF air conditioning | 6 |
| R454B | stationary VRF air conditioning | 7 |
| R454B | stationary VRF air conditioning | 8 |
| R454B | stationary VRF air conditioning | 9 |
| R454B | stationary VRF air conditioning | 10 |
| R454B | chiller (including air cooled chillers) | 1 |
| R454B | chiller (including air cooled chillers) | 2 |
| R454B | chiller (including air cooled chillers) | 3 |
| R454B | chiller (including air cooled chillers) | 4 |
| R454B | chiller (including air cooled chillers) | 5 |
| R454B | chiller (including air cooled chillers) | 6 |
| R454B | chiller (including air cooled chillers) | 7 |
| R454B | chiller (including air cooled chillers) | 8 |
| R454B | chiller (including air cooled chillers) | 9 |
| R454B | chiller (including air cooled chillers) | 10 |
| R454B | heat pump | 1 |
| R454B | heat pump | 2 |
| R454B | heat pump | 3 |
| R454B | heat pump | 4 |
| R454B | heat pump | 5 |
| R454B | heat pump | 6 |
| R454B | heat pump | 7 |
| R454B | heat pump | 8 |
| R454B | heat pump | 9 |
| R454B | heat pump | 10 |
| R454B | residential air-to-water heat pump | 1 |
| R454B | residential air-to-water heat pump | 2 |
| R454B | residential air-to-water heat pump | 3 |
| R454B | residential air-to-water heat pump | 4 |
| R454B | residential air-to-water heat pump | 5 |
| R454B | residential air-to-water heat pump | 6 |
| R454B | residential air-to-water heat pump | 7 |
| R454B | residential air-to-water heat pump | 8 |
| R454B | residential air-to-water heat pump | 9 |
| R454B | residential air-to-water heat pump | 10 |
| R454B | commercial refrigeration | 1 |
| R454B | commercial refrigeration | 2 |
| R454B | commercial refrigeration | 3 |
| R454B | commercial refrigeration | 4 |
| R454B | commercial refrigeration | 5 |
| R454B | commercial refrigeration | 6 |
| R454B | commercial refrigeration | 7 |
| R454B | commercial refrigeration | 8 |
| R454B | commercial refrigeration | 9 |
| R454B | commercial refrigeration | 10 |
| R454B | commercial low temperature refrigeration | 1 |
| R454B | commercial low temperature refrigeration | 2 |
| R454B | commercial low temperature refrigeration | 3 |
| R454B | commercial low temperature refrigeration | 4 |
| R454B | commercial low temperature refrigeration | 5 |
| R454B | commercial low temperature refrigeration | 6 |
| R454B | commercial low temperature refrigeration | 7 |
| R454B | commercial low temperature refrigeration | 8 |
| R454B | commercial low temperature refrigeration | 9 |
| R454B | commercial low temperature refrigeration | 10 |
| R454B | commercial medium temperature refrigeration | 1 |
| R454B | commercial medium temperature refrigeration | 2 |
| R454B | commercial medium temperature refrigeration | 3 |
| R454B | commercial medium temperature refrigeration | 4 |
| R454B | commercial medium temperature refrigeration | 5 |
| R454B | commercial medium temperature refrigeration | 6 |
| R454B | commercial medium temperature refrigeration | 7 |
| R454B | commercial medium temperature refrigeration | 8 |
| R454B | commercial medium temperature refrigeration | 9 |
| R454B | commercial medium temperature refrigeration | 10 |

### Retrofit Uses

The present invention also includes, and provides particular advantage in connection with, use of the refrigerants of the present invention, including Refrigerants 1 - 10 as a retrofit for heat transfer systems.

The present invention also includes, and provides particular advantage in connection with, use of the refrigerants of the present invention, including Refrigerants 1 - 10 as a retrofit for R-32 contained in a stationary air conditioning system.

The present invention also includes, and provides particular advantage in connection with, use of the refrigerants of the present invention, including Refrigerants 1 - 10 as a retrofit for R-32 contained in a chiller system.

The present invention also includes, and provides particular advantage in connection with, use of the refrigerants of the present invention, including Refrigerants 1 - 10 as a retrofit for R-32 contained in a heat pump system.

The present invention also includes, and provides particular advantage in connection with, use of the refrigerants of the present invention, including Refrigerants 1 - 10 as a retrofit for R-32 contained in a commercial refrigeration system.

The present invention also includes, and provides particular advantage in connection with, use of the refrigerants of the present invention, including Refrigerants 1 - 10 as a retrofit for R-454B in a heat transfer system.

The present invention also includes, and provides particular advantage in connection with, use of the refrigerants of the present invention, including Refrigerants 1 - 10 as a retrofit for R-454B contained in a stationary air conditioning system.

The present invention also includes, and provides particular advantage in connection with, use of the refrigerants of the present invention, including Refrigerants 1 - 10 as a retrofit for R-454B contained in a chiller system.

The present invention also includes, and provides particular advantage in connection with, use of the refrigerants of the present invention, including Refrigerants 1 - 10 as a retrofit for R-454B contained in a heat pump system.

The present invention also includes, and provides particular advantage in connection with, use of the refrigerants of the present invention, including Refrigerants 1 - 10 as a retrofit for R-454B contained in a commercial refrigeration system.

### Cooling Methods

The present invention includes methods for providing cooling comprising:
(a) evaporating a refrigerant according to the present invention (including any refrigerant selected from each of Refrigerants 1 - 10), in the vicinity of the body or article or fluid to be cooled at a temperature of from about -40° C. to about +10° C. to produce a refrigerant vapor;
(b) compressing said refrigerant vapor to produce a refrigerant at discharge temperature of less than about 150° C.; and
(c) condensing the refrigerant from said compressor at a temperature of from about 20° C. to about 70° C. to produce a refrigerant vapor. Cooling methods in accordance with this paragraph are referred to herein as Cooling Method 1.

The present invention includes methods according to Cooling Method 1 wherein the refrigerant in said evaporating step has a refrigerant glide of less than 3.5° C. Cooling methods in accordance with this paragraph are referred to herein as Cooling Method 2.

The present invention includes methods according to Cooling Method 1 wherein the refrigerant in said evaporating step has a refrigerant glide of less than 3.0° C. Cooling methods in accordance with this paragraph are referred to herein as Cooling Method 3.

The present invention includes methods according to Cooling Method 1 wherein the refrigerant in said evaporating step has a refrigerant glide of less than 2.5° C. Cooling methods in accordance with this paragraph are referred to herein as Cooling Method 4.

The present invention includes conducting cooling according to any of Cooling Methods 1 - 4 in a stationary air conditioning system.

The present invention includes conducting cooling according to any of Cooling Methods 1 - 4 in a stationary residential air conditioning system.

The present invention includes conducting cooling according to any of Cooling Methods 1 - 4 in a stationary commercial air conditioning system.

The present invention includes conducting cooling according to any of Cooling Methods 1 - 4 in a stationary VRF air conditioning system.

The present invention includes conducting cooling according to any of Cooling Methods 1 - 4 in a chiller system.

The present invention includes conducting cooling according to any of Cooling Methods 1 - 4 in an air-cooled chiller system.

The present invention includes conducting cooling according to any of Cooling Methods 1 - 4 in a heat pump system.

The present invention includes conducting cooling according to any of Cooling Methods 1 - 4 in a residential air-to-water heat pump system.

The present invention includes conducting cooling according to any of Cooling Methods 1 - 4 in a commercial refrigeration system.

The present invention includes conducting cooling according to any of Cooling Methods 1 - 4 in a commercial low temperature refrigeration system.

The present invention includes conducting cooling according to any of Cooling Methods 1 - 4 in a commercial medium temperature refrigeration system.

Particular cooling methods include those identified by the indicated Cooling Method number in the following table, with the number in the Refrigerant column being reference to the Refrigerant number as defined herein, and with all temperature values being preceded by “about.”

| Method No. | System Type | Refrigerant No(s). | Refrigerant Process Temperatures, °C. | | | Refrigerant Evap. Glide, C |
|---|---|---|---|---|---|---|
| | | | Evaporating | Compressor Discharge | Condensing | |
| Cooing Method 5A | Residential air conditioning | 1-10 | 0 to 10 | <150 | from 40 to 70 | <3.5 |
| Cooing Method 5B | Residential air conditioning | 1-10 | from 0 to 10 | <150 | from 40 to 70 | <3 |
| Cooing Method 5C | Residential air conditioning | 7 | from 0 to 10 | <150 | from 40 to 70 | <3 |
| Cooing Method 5D | Residential air conditioning | 8 | from 0 to 10 | <150 | from 40 to 70 | <3 |
| Cooing Method 5E | Residential air conditioning | 9 | from 0 to 10 | <150 | from 40 to 70 | <3 |
| Cooing Method 5F | Residential air conditioning | 10 | from 0 to 10 | <150 | from 40 to 70 | <3 |
| Cooing Method 6A | Chiller | 1-10 | from 0 to 10 | <150 | from 40 to 70 | <3.5 |
| Cooing Method 6B | Chiller | 1-10 | from 0 to 10 | <150 | from 40 to 70 | <3 |
| Cooing Method 6C | Chiller | 7 | from 0 to 10 | <150 | from 40 to 70 | <3 |
| Cooing Method 6D | Chiller | 8 | from 0 to 10 | <150 | from 40 to 70 | <3 |
| Cooing Method 6E | Chiller | 9 | from 0 to 10 | <150 | from 40 to 70 | <3 |
| Cooing Method 6F | Chiller | 10 | from 0 to 10 | <150 | from 40 to 70 | <3 |
| Cooing Method 7A | Low temperature refrigeration | 1-10 | from -40 to -12 | <150 | from 20 to 60 | < 3.5 |
| Cooing Method 7B | Low temperature refrigeration | 7 | from -40 to -12 | <150 | from 20 to 60 | < 3.5 |
| Cooing Method 7C | Low temperature refrigeration | 8 | from -40 to -12 | <150 | from 20 to 60 | < 3.5 |
| Cooing Method 7D | Low temperature refrigeration | 9 | from -40 to -12 | <150 | from 20 to 60 | < 3.5 |
| Cooing Method 7E | Low temperature refrigeration | 10 | from -40 to -12 | <150 | from 20 to 60 | < 3.5 |
| Cooing Method 7F | Low temperature refrigeration | 1-10 | from -40 to -12 | <150 | from 20 to 60 | <3 |
| Cooing Method 7G | Low temperature refrigeration | 7 | from -40 to -12 | <150 | from 20 to 60 | <3 |
| Cooing Method 7H | Low temperature refrigeration | 8 | from -40 to -12 | <150 | from 20 to 60 | <3 |
| Cooing Method 71 | Low temperature refrigeration | 9 | from -40 to -12 | <150 | from 20 to 60 | <3 |
| Cooing Method 7J | Low temperature refrigeration | 10 | from -40 to -12 | <150 | from 20 to 60 | <3 |
| Cooing Method 8A | Medium temperature refrigeration | 1-10 | from -12 to 0 | <150 | from 20 to 60 | < 3.5 |
| Cooing Method 8B | Medium temperature refrigeration | 7 | from -12 to 0 | <150 | from 20 to 60 | < 3.5 |
| Cooing Method 8C | Medium temperature refrigeration | 8 | from -12 to 0 | <150 | from 20 to 60 | < 3.5 |
| Cooing Method 8D | Medium temperature refrigeration | 9 | from -12 to 0 | <150 | from 20 to 60 | < 3.5 |
| Cooing Method 8E | Medium temperature refrigeration | 10 | from -12 to 0 | <150 | from 20 to 60 | < 3.5 |
| Cooing Method 8F | Medium temperature refrigeration | 1-10 | from -12 to 0 | <150 | from 20 to 60 | <3 |
| Cooing Method 8G | Medium temperature refrigeration | 7 | from -12 to 0 | <150 | from 20 to 60 | <3 |
| Cooing Method 8H | Medium temperature refrigeration | 8 | from -12 to 0 | <150 | from 20 to 60 | <3 |
| Cooing Method 8l | Medium temperature refrigeration | 9 | from -12 to 0 | <150 | from 20 to 60 | <3 |
| Cooing Method 8J | Medium temperature refrigeration | 10 | from -40 to -12 | <150 | from 20 to 60 | <3 |

### Heating Methods

Particular heating methods include those identified by the indicated Heating Method number in the following table, with the number in the Refrigerant column being reference to the Refrigerant number as defined herein, and with all temperature values being preceded by “about.”

| Method No. | System Type | Refrigerant No(s). | Refrigerant Process Temperatures, °C. | | | Refrigerant Evap. Glide, C |
|---|---|---|---|---|---|---|
| | | | Evaporating | Compressor Discharge | Condensing | |
| Heating Method 1A | Residential air conditioning | 1-10 | from -20 to 3 | <150 | from 40 to 70 | <3.5 |
| Heating Method 1B | Residential air conditioning | 1-10 | from -20 to 3 | <150 | from 40 to 70 | <3 |
| Heating Method 1C | Residential air conditioning | 7 | from -20 to 3 | <150 | from 40 to 70 | <3 |
| Heating Method 1D | Residential air conditioning | 8 | from -20 to 3 | <150 | from 40 to 70 | <3 |
| Heating Method 1E | Residential air conditioning | 9 | from -20 to 3 | <150 | from 40 to 70 | <3 |
| Heating Method 1F | Residential air conditioning | 10 | from -20 to 3 | <150 | from 40 to 70 | <3 |
| Heating Method 2A | residential air to water heat pump | 1-10 | from -30 to 5 | <150 | from 50 to 90 | <3 |
| Heating Method 2B | residential air to water heat pump | 7 | from -30 to 5 | <150 | from 50 to 90 | <3 |
| Heating Method 2C | residential air to water heat pump | 8 | from -30 to 5 | <150 | from 50 to 90 | <3 |
| Heating Method 2D | residential air to water heat pump | 9 | from -30 to 5 | <150 | from 50 to 90 | <3 |
| Heating Method 2E | residential air to water heat pump | 10 | from -30 to 5 | <150 | from 50 to 90 | <3 |
| Heating Method 2F | residential air to water heat pump | 1-10 | from -30 to 5 | <150 | from 50 to 90 | < 3.5 |
| Heating Method 2G | residential air to water heat pump | 7 | from -30 to 5 | <150 | from 50 to 90 | < 3.5 |
| Heating Method 2H | residential air to water heat pump | 8 | from -30 to 5 | <150 | from 50 to 90 | < 3.5 |
| Heating Method 2l | residential air to water heat pump | 9 | from -30 to 5 | <150 | from 50 to 90 | < 3.5 |
| Heating Method 2J | residential air to water heat pump | 10 | from -30 to 5 | <150 | from 50 to 90 | < 3.5 |
| Heating Method 3A | residential air to water heat pump | 1-10 | from -20 to 3 | <150 | from 50 to 90 | <3 |
| Heating Method 3B | residential air to water heat pump | 1-10 | from -20 to 3 | <150 | from 50 to 90 | <3 |
| Heating Method 3C | residential air to water heat pump | 7 | from -20 to 3 | <150 | from 50 to 90 | <3 |
| Heating Method 3D | residential air to water heat pump | 8 | from -20 to 3 | <150 | from 50 to 90 | <3 |
| Heating Method 3E | residential air to water heat pump | 9 | from -20 to 3 | <150 | from 50 to 90 | <3 |
| Heating Method 3F | residential air to water heat pump | 10 | from -20 to 3 | <150 | from 50 to 90 | <3 |
| Heating Method 3G | residential air to water heat pump | 1-10 | from -20 to 3 | <150 | from 50 to 90 | < 3.5 |
| Heating Method 3l | residential air to water heat pump | 7 | from -20 to 3 | <150 | from 50 to 90 | < 3.5 |
| Heating Method 3J | residential air to water heat pump | 8 | from -20 to 3 | <150 | from 50 to 90 | < 3.5 |
| Heating Method 3K | residential air to water heat pump | 9 | from -20 to 3 | <150 | from 50 to 90 | < 3.5 |
| Heating Method 3L | residential air to water heat pump | 10 | from -20 to 3 | <150 | from 50 to 90 | < 3.5 |

The present invention includes methods of providing heating air, including each of Heating Methods 1, wherein said method provides heated air at a temperature of from about 15° C. to about 25° C.

The present invention includes methods of providing heating air, including each of Heating Methods 1, wherein said method provides heated air at a temperature of from about 18° C. to about 24° C.

The present invention includes methods of providing heating, including each of Heating Methods 2 and 3, wherein said method provides heated water at a temperature of from about 50° C. to about 65° C.

The present invention includes methods of providing heating, including each of Heating Methods 2 and 3, wherein said method provides heated water at a temperature of from about 50° C. to about 60° C.

The present invention includes methods of providing heating, including each of Heating Methods 2 and 3, wherein said method provides heated water at a temperature of from about 50° C. to about 55° C.

### Equipment for the Systems, Methods and Uses

Examples of commonly used compressors, for the purposes of this invention include reciprocating, rotary (including rolling piston and rotary vane), scroll, screw, and centrifugal compressors. Thus, the present invention provides each and any of the refrigerants, including each of Refrigerants 1 - 10, and/or heat transfer compositions as described herein, including those containing any one of Refrigerants 1 - 10, for use in a heat transfer system comprising a reciprocating, rotary (including rolling piston and rotary vane), scroll, screw, or centrifugal compressor.

Examples of commonly used expansion devices, for the purposes of this invention include a capillary tube, a fixed orifice, a thermal expansion valve and an electronic expansion valve. Thus, the present invention provides each and any of the refrigerants, including each of Refrigerants 1 - 10, and/or heat transfer compositions, including those containing any one of Refrigerants 1 - 10, as described herein for use in a heat transfer system comprising a capillary tube, a fixed orifice, a thermal expansion valve or an electronic expansion valve.

For the purposes of this invention, the evaporator and the condenser can each independently be selected from a finned tube heat exchanger, a microchannel heat exchanger, a shell and tube, a plate heat exchanger, and a tube-in-tube heat exchanger. Thus, the present invention provides each and any of the refrigerants and/or heat transfer compositions as described herein for use in a heat transfer system wherein the evaporator and condenser together form a finned tube heat exchanger, a microchannel heat exchanger, a shell and tube, a plate heat exchanger, or a tube-in-tube heat exchanger.

The heat transfer composition of the invention can be used in heating and cooling applications. In a particular feature of the invention, the heat transfer composition can be used in a method of cooling comprising condensing a heat transfer composition and subsequently evaporating said composition in the vicinity of an article or body to be cooled.

The refrigerants of the present invention, including Refrigerants 1 - 10, and heat transfer compositions of the invention, including Heat Transfer Compositions 1 - 25, are each is provided for use in commercial refrigeration systems, including use in each of the following:
low temperature commercial refrigerator,
supermarket refrigeration,
a low temperature commercial freezer,
an ice making machine,
a vending machine,
a low temperature transport refrigeration system,
an industrial freezer,
an industrial refrigerator and
a low temperature chiller.

The heat transfer composition of the invention is provided for use in a medium temperature refrigeration system, wherein the medium temperature refrigeration system is preferably used to chill food or beverages such as in a refrigerator or a bottle cooler. The system usually has an air-to-refrigerant evaporator to chill the food or beverage, a reciprocating, scroll or screw or rotary compressor, an air-to-refrigerant condenser to exchange heat with the ambient air, and a thermal or electronic expansion valve.

The heat transfer composition of the invention is provided for use in a low temperature refrigeration system, wherein said low temperature refrigeration system is preferably used in a freezer or an ice making machine. The system usually has an air-to-refrigerant evaporator to chill the food or beverage, a reciprocating, scroll or rotary compressor, an air-to-refrigerant condenser to exchange heat with the ambient air, and a thermal or electronic expansion valve.

Each of the heat transfer compositions described herein, including heat transfer compositions containing any one of Refrigerants 1 - 10, is particularly provided for use in a low temperature system with a reciprocating, rotary (rolling-piston or rotary vane) or scroll compressor.

Each of the heat transfer compositions described herein, including heat transfer compositions containing any one of Refrigerants 1 - 10, is particularly provided for use in a medium temperature system with a reciprocating, rotary (rolling-piston or rotary vane) or scroll compressor.

The compositions of the present invention exhibit many of the desirable characteristics of R-410A but have a sub-300 GWP while at the same time having operating characteristics i.e., capacity and efficiency (COP) that are substantially similar to or substantially match R-410A. This allows the claimed compositions to replace R-410A in existing heat transfer systems without requiring any significant system modification for example of the condenser, the evaporator and/or the expansion valve. The composition can therefore be used as a direct replacement which have been used with or are suitable for use with R-410A.

The refrigerants of the invention, including each of Refrigerants 1 - 10, therefore preferably exhibit operating characteristics compared with R-410A wherein the efficiency (COP) of the composition is from 95 to 105% of the efficiency of R-410A in heat transfer systems, in which the compositions of the invention are to replace the R-410A refrigerant.

The refrigerants of the invention, including each of Refrigerants 1 - 10, therefore preferably exhibits operating characteristics compared with R-410A wherein the capacity of the composition is from 97 to 103% of the capacity of R-410A in heat transfer systems, in which the compositions of the invention are to replace the R-410A refrigerant.

The refrigerants of the invention, including each of Refrigerants 1 - 10, therefore preferably exhibits operating characteristics compared with R-410A wherein the capacity of the composition is from 97 to 103% of the capacity of R-410A in heat transfer systems and wherein the efficiency (COP) is equal to or greater than the efficiency of R-410A in the heat transfer system, in which the compositions of the invention are to replace the R-410A refrigerant.

Preferably, the refrigerants of the invention, including each of Refrigerants 1 -102, preferably exhibit operating characteristics compared with R-410A wherein the efficiency (COP) of the composition is from 100 to 105% of the efficiency of R-410A in heat transfer systems, in which the compositions of the invention are to replace the R-410A refrigerant.

In order to maintain reliability of the heat transfer system, it is preferred that the composition of the invention further exhibits the following characteristics compared with R-410A:
the discharge temperature is not greater than 10° C. higher than that of R-410A; and
the compressor pressure ratio is from 95 to 105% of the compressor pressure ratio of R-410A
in heat transfer systems, in which the composition of the invention is used to replace the R-410A refrigerant.

The composition of the invention is alternatively provided to replace R-410A in refrigeration systems. Thus, each of the heat transfer compositions as described herein, including heat transfer compositions that include any one of Refrigerants 1-10 can be used to replace R-410A in any one of the systems disclosed herein.

The present invention relates to the use in a medium or low temperature refrigeration system of a refrigerant of the present invention, including each of Refrigerant 1 -10, wherein the refrigerant
(a) has an efficiency (COP) from about 95% to about 105% of the efficiency of R-410A in said system; and
(b) is mildly flammable.

### EXAMPLES

### Comparative Example 1

Two compositions as indicated below in Table CE1 were evaluated for comparison to preferred formulations of the invention:

Table EC1

| | CE1 | CE2 |
|---|---|---|
| Component | | |
| HFC-32 | 43.5 | 60.0 |
| HFO-1234yf | 49.5 | 20.0 |
| R161 | 7.0 | 20.0 |
| Total | 100.0 | 100.0 |
| Burning Velocity | 10.8 | >> 10 |

The composition identified as CE1 was tested to obtain the experimental data needed to determine by simulation burning velocity based on ASHRAE Standard 34 and was found to have a burning velocity on this basis of 10.8 cm/sec. Accordingly, this composition did not satisfy the requirements Class 2L refrigerant (mild flammability) according to ASHRAE. The composition identified as CE1 is tested pursuant to ASHRAE Standard 34 and found to have a burning velocity of much greater than 10 and would also not be classified as Class 2L and therefore would be considered flammable.

### Examples 1 - 6

Two compositions in accordance with the present invention are formulated as indicated in Table E1- 6 below:

Table E1-6

| | E1 | E2 | E3 | E4 | E5 | E6 |
|---|---|---|---|---|---|---|
| Component | | | | | | |
| HFC-32 | 43.5 | 43.5 | 43.5 | 41.0 | 42.0 | 43.0 |
| HFO-1234yf | 52.5 | 51.5 | 50.5 | 55.0 | 54.0 | 53.0 |
| R161 | 4.0 | 5.0 | 6.0 | 4.0 | 4.0 | 4.0 |
| Total | 100.0 | 100 | 100 | 100.0 | 100.0 | 100.0 |
| Burning Velocity | 7.7 | <10 | 9.7 | <10 | <10 | < 10 |
| Flammability | 2L | 2L | 2L | 2L | 2L | 2L |
| GWP | 295 | 295 | 295 | 278 | 285 | 291 |

As can be seen from Table E1-6 above, all of the compositions tested achieve a burning velocity of less than 10 and are therefore Class 2L refrigerants, and at the same time each refrigerant also has a GWP of less than 300. This is an unexpected combination of properties.

### System Performance Examples

In the system performance Examples which follow, the refrigerants identified as E1 and E2 in Table E1-6 above were analyzed as described herein. Each composition was subjected to thermodynamic analysis to determine its ability to match the operating characteristics of R-410A in various refrigeration systems. The analysis was performed using experimental data collected for properties of various binary pairs of components used in the composition. The vapor/liquid equilibrium behavior of each component was determined and studied in a series of binary pairs with each of HFO-1234yf, HFC-32, and HFC-161. The composition of each binary pair was varied over a series of relative percentages in the experimental evaluation and the mixture parameters for each binary pair were regressed to the experimentally obtained data. Vapor/liquid equilibrium behavior data for binary pairs are available in the National Institute of Science and Technology (NIST) Reference Fluid Thermodynamic and Transport Properties Database software (Refprop 9.1 NIST Standard Database 2013) and were used for the Examples. The parameters selected for conducting the analysis were: same compressor displacement for all refrigerants, same operating conditions for all refrigerants, same compressor isentropic and volumetric efficiency for all refrigerants. In each Example, simulations were conducted using the measured vapor liquid equilibrium data. The simulation results are reported for each Example.

### Example E7 - Residential Air-Conditioning System (Cooling)

A residential air-conditioning system used to supply cool air (about 12° C.) to buildings in the summer is tested. Typical system types include ducted split, ductless split, window and portable air-conditioning systems. The system usually has an air-to-refrigerant evaporator (indoor coil), a compressor, an air-to-refrigerant condenser (outdoor coil), and an expansion device. The evaporator and condenser are commonly finned tube or microchannel heat exchangers. The compressor is commonly reciprocating, rotary (rolling-piston or rotary vane) or scroll compressor. The expansion device is commonly a capillary tube, a thermal or electronic expansion valve. The refrigerant evaporating temperature is commonly in the range of about 0 to about 10° C., while the condensing temperature is in the range of about 40 to about 70° C.

Refrigerants E1 and E2 were used in a simulation of a residential air-conditioning system as described above and the performance results are reported in Table 7 below. Operating conditions were: Condensing temperature= 46° C. (corresponding outdoor ambient temperature= 35° C.); Condenser sub-cooling= 5.5° C.; Evaporating temperature= 7° C. (corresponding indoor ambient temperature= 26.7° C.); Evaporator Superheat= 5.5° C.; Isentropic Efficiency= 70%; Volumetric Efficiency= 100%; and Temperature Rise in Suction Line=5.5° C.

Table E7

Performance in Residential Air-Conditioning System (Cooling)

| Refrigerant | Capacity (%R410A) | Efficiency (%R410A) | Pressure ratio (%R410A) | Discharge Pressure (%R410A) | Discharge Temperature Difference (°C) | Evap Glide (°C) |
|---|---|---|---|---|---|---|
| R410A | 100% | 100% | 100% | 100% | 0.0 | 0.1 |
| E1 | 83% | 103% | 102% | 81% | -1.3 | 3.4 |
| E2 | 83% | 103% | 102% | 80% | -1.1 | 3.3 |

⮚Table E7 shows the thermodynamic performance of a residential air-conditioning system compared to R410A system.
⮚For new systems, compressor displacement can be increased to make up capacity.
⮚Composition E1 to E2 each are unexpectedly able to achieve an evaporator glide of less than 4° C. in this system while at the same time achieving a GWP of less than 300 and a flammability rating of 2L.

### Example 8 - Variable Refrigerant Flow Air-Conditioning System (Cooling)

Variable refrigerant flow air-conditioning systems (VRFs) are commonly used to supply cool air (about 12° C.) to buildings in the summer. VRFs are typically installed with an air conditioner inverter which adds a DC inverter to the compressor to support variable motor speed and thus variable refrigerant flow rather than simply perform on/off operation. By operating at varying speeds, VRF units work only at the needed rate allowing for substantial energy savings at load conditions. The compressor is usually rotary or scroll compressor. The expansion device is usually a thermal or electronic expansion valve. The refrigerant evaporating temperature is commonly in the range of about 0 to about 10° C., while the condensing temperature is commonly in the range of about 40 to about 70° C.

A VRF system used to supply cool air (about 12° C.) to buildings in the summer is tested. Refrigerants E1 and E2 were used in a simulation of a VRF as described above and the performance results are reported in Table E8 below. Operating conditions were: Condensing temperature= 46° C. (corresponding outdoor ambient temperature= 35° C.); Condenser sub-cooling= 5.5° C.; Evaporating temperature= 7° C. (corresponding indoor ambient temperature= 26.7° C.); Evaporator Superheat= 5.5° C.; Isentropic Efficiency= 70%; Volumetric Efficiency= 100%; and Temperature Rise in Suction Line=5.5° C.

Table E8

Performance in VRF System (Cooling)

| NRefrigerant | Capacity (%R410A) | Efficiency (%R410A) | Pressure ratio (%R410A) | Discharge Pressure (%R410A) | Discharge Temperature Difference (°C) | Evap Glide (°C) |
|---|---|---|---|---|---|---|
| R410A | 100% | 100% | 100% | 100% | 0.0 | 0.1 |
| E1 | 83% | 103% | 102% | 81% | -1.3 | 3.4 |
| E2 | 83% | 103% | 102% | 80% | -1.1 | 3.3 |

⮚Table E8 shows the thermodynamic performance of a variable refrigerant flow air-conditioning systems compared to R410A system.
⮚For new systems, compressor displacement can be increased to make up capacity.
⮚Composition E1 to E2 each are unexpectedly able to achieve an evaporator glide of less than 4° C. in this system while at the same time achieving a GWP of less than 300 and a flammability rating of 2L.

### Example 9 - Commercial Air-Conditioning System – Chiller

Commercial air-conditioning systems (chillers) are commonly used to supply chilled water (about 7° C.) to large buildings such as offices, hospitals, etc. Depending on the application, the chiller system may be running all year long. The chiller system may be air-cooled or water-cooled. The air-cooled chiller usually has a plate, tube-in-tube or shell-and-tube evaporator to supply chilled water, a reciprocating or scroll compressor, a round tube plate fin or microchannel condenser to exchange heat with ambient air, and a thermal or electronic expansion valve. The water-cooled system usually has a shell-and-tube evaporator to supply chilled water, a reciprocating or scroll compressor, a shell-and-tube condenser to exchange heat with water from cooling tower or lake, sea and other natural recourses, and a thermal or electronic expansion valve. The refrigerant evaporating temperature is commonly in the range of about 0 to about 10° C., while the condensing temperature is in the range of about 40 to about 70° C.

A commercial air-conditioning system (chiller) used to supply chilled water (7° C.) to large buildings (such as office and hospital buildings) is tested with respect to refrigerants E1 and E2, and the performance results are reported in Table E9 below. Operating conditions were: Condensing temperature= 46° C.; Condenser sub-cooling= 5.5° C.; Evaporating temperature= 4.5° C.; Evaporator Superheat= 5.5° C.; Isentropic Efficiency= 70%; Volumetric Efficiency= 100%; and Temperature Rise in Suction Line=2° C.

Table E9

Performance in Commercial Air-Conditioning System - Air-Cooled Chiller

| Refrigerant | Capacity (%R410A) | Efficiency (%R410A) | Pressure ratio (%R410A) | Discharge Pressure (%R410A) | Discharge Temperature Difference (°C) | Evap Glide (°C) |
|---|---|---|---|---|---|---|
| R410A | 100% | 100% | 100% | 100% | 0.0 | 0.1 |
| E1 | 82% | 103% | 102% | 81% | -1.4 | 3.3 |
| E2 | 82% | 103% | 102% | 80% | -1.1 | 3.3 |

⮚Table E9 shows the thermodynamic performance of a commercial air-cooled chiller system compared to R410A system.

For new systems, compressor displacement can be increased to make up capacity. Composition E1 and E2 each are unexpectedly able to achieve an evaporator glide of less than 4° C. in this system while at the same time achieving a GWP of less than 300 and a flammability rating of 2L

### Example 10 - Residential Heat Pump System (Heating)

Residential heat pump systems are used to supply warm air (21° C.) to buildings in the winter and are typically configured the same as residential air-conditioning systems. However, when such systems are operating in the heat pump mode, the refrigerant flow is reversed, and the indoor coil becomes a condenser, and the outdoor coil becomes evaporator. Typical system types are ducted split and ductless split heat pump system. The evaporator and condenser are typically finned tube or microchannel heat exchangers, and the compressor is typically a reciprocating or rotary (rolling-piston or rotary vane) or scroll compressor. The expansion device is commonly a capillary tube, a thermal or electronic expansion valve. The refrigerant evaporating temperature is commonly in the range of about -30 to about 5° C., while the condensing temperature is in the range of about 35 to about 50° C.

The refrigerants E1 and E2 were used in a simulation of a residential heat pump system as described above and the performance results are in Table E10 below. Operating conditions were: Condensing temperature= 41° C.; Condenser sub-cooling= 5.5° C.; Evaporating temperature= 0.5° C.; Evaporator Superheat= 5.5° C.; Isentropic Efficiency= 70%; Volumetric Efficiency= 100%; and Temperature Rise in Suction Line=5.5° C.

Table E10

Performance in Residential Heat pump System (Heating)

| Refrigerant | Heating Capacity (%R410A) | Heating Efficiency (%R410A) | Pressure ratio (%R410A) | Discharge Pressure (%R410A) | Discharge Temperature Difference (°C) | Evap Glide (°C) |
|---|---|---|---|---|---|---|
| R410A | 100% | 100% | 100% | 100% | 0.0 | 0.1 |
| A1 | 82% | 103% | 102% | 81% | -1.5 | 3.4 |
| A2 | 82% | 103% | 102% | 80% | -1.3 | 3.4 |

⮚ Table E10 shows the thermodynamic performance of a residential heat pump system compared to R410A system.
⮚For new systems, compressor displacement can be increased to make up capacity.
⮚Composition E1 to E2 each are unexpectedly able to achieve an evaporator glide of less than 4° C. in this system while at the same time achieving a GWP of less than 300 and a flammability rating of 2L.

### Example 11 - Residential Air-to-Water Heat Pump Hydronic System

Residential air-to-water heat pump hydronic systems are typically used to supply hot water (about 55° C.) to buildings for floor heating or similar applications in the winter. The hydronic system usually has a finned or microchannel evaporator to exchange heat with ambient air, a reciprocating, rotary or scroll compressor, a plate, tube-in-tube or shell-and-tube condenser to heat the water, and a thermal or electronic expansion valve. The refrigerant evaporating temperature is typically in the range of about -30 to about 5° C., while the condensing temperature is typically in the range of about 50 to about 90° C.

A residential air-to-water heat pump hydronic system used to supply hot water (55° C.) to buildings for floor heating or similar applications in the winter is tested with Refrigerants E1 and E2 and the performance results are reported in Table E115. Operating conditions were: Condensing temperature= 60° C. (corresponding indoor leaving water temperature= 50° C.); Condenser sub-cooling= 5.5° C.; Evaporating temperature= 0.5° C. (corresponding outdoor ambient temperature= 8.3° C.); Evaporator Superheat= 5.5° C.; Isentropic Efficiency= 70%; Volumetric Efficiency= 100%; and Temperature Rise in Suction Line=2° C.

Table E11

Performance in Residential Air-to-Water Heat Pump Hydronic System

| Refrigerant | Heating Capacity (%R410A) | Heating Efficiency (%R410A) | Pressure ratio (%R410A) | Discharge Pressure (%R410A) | Discharge Temperature Difference (°C) | Evap Glide (°C) |
|---|---|---|---|---|---|---|
| R410A | 100% | 100% | 100% | 100% | 0.0 | 0.1 |
| E1 | 83% | 105% | 103% | 81% | -3.0 | 2.9 |
| E2 | 83% | 105% | 103% | 80% | -2.7 | 2.9 |

⮚Table E11 shows the thermodynamic performance of a residential air-to-water heat pump hydronic system compared to R410A system.
⮚For new systems, compressor displacement can be increased to make up capacity.

Composition E1 to E2 each are unexpectedly able to achieve an evaporator glide of less than 3° C. in this system while at the same time achieving a GWP of less than 300 and a flammability rating of 2L.

### Example 12 - Medium Temperature Refrigeration System

Medium temperature refrigeration systems are used to chill food or beverages such as in a refrigerator and bottle cooler. The system usually has an air-to-refrigerant evaporator to chill the food or beverage, a reciprocating, scroll or screw compressor, an air-to-refrigerant condenser to exchange heat with the ambient air, and a thermal or electronic expansion valve. The refrigerant evaporating temperature is in the range of about -12 to about 0° C., while the condensing temperature is in the range of about 20 to about 70° C.

A medium temperature refrigeration system used to chill the food or beverage such as in refrigerator and bottle cooler is tested with refrigerants EA1 and E2, and the performance results are reported in Table E12 below. Operating conditions were: Condensing temperature= 40.6° C.; Condenser sub-cooling= 5.5° C.; Evaporating temperature= -6.7° C.; Evaporator Superheat= 5.5° C.; Isentropic Efficiency= 70%; Volumetric Efficiency= 100%; Degree of superheat in the suction line = 15° C.

Table E12

Performance in Medium Temperature Refrigeration System

| Refrigerant | Capacity (%R410A) | Efficiency (%R410A) | Pressure ratio (%R410A) | Discharge Pressure (%R410A) | Discharge Temperature Difference (°C) | Evap Glide (°C) |
|---|---|---|---|---|---|---|
| R410A | 100% | 100% | 100% | 100% | 0.0 | 0.1 |
| E1 | 82% | 103% | 102% | 81% | -2.8 | 3.3 |
| E2 | 82% | 103% | 102% | 80% | -2.5 | 3.3 |

⮚Table E12 shows the thermodynamic performance of a medium temperature refrigeration system compared to R410A system.
⮚For new systems, compressor displacement can be increased to make up capacity.
⮚Composition E1 to E2 each are unexpectedly able to achieve an evaporator glide of less than 4° C. in this system while at the same time achieving a GWP of less than 300 and a flammability rating of 2L.

### Example 13 - Low Temperature Refrigeration System

Low temperature refrigeration systems are used to freeze food such as in an ice cream machine and a freezer. The system usually has an air-to-refrigerant evaporator, a reciprocating, scroll or screw compressor, an air-to-refrigerant condenser to exchange heat with the ambient air, and a thermal or electronic expansion valve. The refrigerant evaporating temperature is in the range of about -40 to about -12° C., while the condensing temperature is in the range of about 20 to about 70° C.

A low temperature refrigeration system used to freeze the food such as in ice cream machine and freezer is tested using refrigerants E1 and E2 and the performance results are in Table E13. Operating conditions were: Condensing temperature= 40.6° C.; Condenser sub-cooling= 1° C.; Evaporating temperature= -31.6° C.; Degree of superheat at evaporator outlet = 5.5° C.; Isentropic Efficiency= 70%; Volumetric Efficiency= 100%; Degree of superheat in the suction line = 30.6° C.

Table E13

Performance in Low Temperature Refrigeration System

| Refrigerant | Capacity (%R410A) | Efficiency (%R410A) | Pressure ratio (%R410A) | Discharge Pressure (%R410A) | Discharge Temperature Difference (°C) | Evap Glide (°C) |
|---|---|---|---|---|---|---|
| R410A | 100% | 100% | 100% | 100% | 0.0 | 0.1 |
| E1 | 80% | 103% | 104% | 81% | -7.0 | 2.9 |
| E2 | 80% | 104% | 104% | 80% | -6.5 | 2.9 |

⮚Table E13 shows the thermodynamic performance of a low temperature refrigeration system compared to R410A system.
⮚For new systems, compressor displacement can be increased to make up capacity.
⮚Composition E1 to E2 each are unexpectedly able to achieve an evaporator glide of less than 4° C. in this system while at the same time achieving a GWP of less than 300 and a flammability rating of 2L.

What is claimed is:

1. A refrigerant comprising at least about 98.5% by weight of the following three compounds, with each compound being present in the following relative percentages:
33.0% to 43.5% by weight difluoromethane (HFC-32);
48.5% to 67.0% by weight of 2,3,3,3-tetrafluoropropene (HFO-1234yf); and
1.0% to 6.0% by weight fluoroethane (HFC-161).

2. The refrigerant of claim 1, wherein the refrigerant is a Class 2L refrigerant, has a GWP of less than 300 and has an evaporator glide of 4° C. or less.

3. The refrigerant of claim 1 comprising at least about 98.5% by weight of the following three compounds, with each compound being present in the following relative percentages:
from 40% to 45% by weight HFC-32;
from 50% to 55% by weight of HFO-1234yf; and
from 1.0% to 6.0% by weight fluoroethane HFC-161.

4. A refrigerant consisting essentially of the following three compounds, with each compound being present in the following relative percentages:
from 40% to 45% by weight HFC-32;
from 49% to 55% by weight of HFO-1234yf; and
from 1.0% to 6.0% by weight of HFC-161.

5. The refrigerant of claim 4 consisting essentially of the following three compounds, with each compound being present in the following relative percentages:
from 41.5% to 44.5% by weight HFC-32;
from 49.5% to 53.5% by weight of HFO-1234yf; and
from 2.0% to 6.0% by weight of HFC-161.

6. The refrigerant of claim 4 consisting essentially of the following three compounds, with each compound being present in the following relative percentages:
from 43.5% +0.5/-2% by weight HFC-32;
from 52.5% +⅟-2% by weight of HFO-1234yf; and
from 4% +⅟-2% by weight of HFC-161.

7. The refrigerant of claim 4 consisting of the following three compounds, with each compound being present in the following relative percentages:
from 43.5% +0.5/-2% by weight HFC-32;
from 52.5% +⅟-2% by weight of HFO-1234yf; and
from 4% +⅟-2% by weight of HFC-161.

8. The refrigerant of claim 4, wherein the refrigerant is a Class 2L refrigerant, has a GWP of less than 300 and has an evaporator glide of less than 5° C.

9. The refrigerant of claim 4, wherein the refrigerant is a Class 2L refrigerant, has a GWP of less than 300 and has an evaporator glide of less than 4° C.

10. The refrigerant of claim 4, wherein the refrigerant is a Class 2L refrigerant, has a GWP of less than 300 and has an evaporator glide of less than 4° C.

11. A heat transfer composition comprising the refrigerant of claim 10 and at least one lubricant.

12. The heat transfer composition of claim 11 wherein said at least one lubricant is selected from POE and PVE.

13. The heat transfer composition of claim 11 wherein said at least one lubricant comprises POE.

14. The heat transfer composition of claim 11 wherein said at least one lubricant comprises PVE.

15. A heat transfer composition comprising a refrigerant according to claim 4.

16. A heat transfer system comprising a compressor, and evaporator and a condenser and containing a refrigerant according to claim 4.

17. A heat transfer system comprising a compressor, and evaporator and a condenser and containing a heat transfer composition according to claim 12.

18. A heat transfer system according to claim 17 wherein said heat transfer system comprises one or more of residential air conditioning, commercial air conditioning, chillers, residential air-to-water heat pump hydronic systems, medium temperature refrigeration and low temperature refrigeration.

19. A heat transfer system according to claim 18 wherein said heat transfer system is an air conditioning system.

20. A heat transfer system according to claim 18 wherein said heat transfer system is a heat pump.
